(19) United States
(12) Patent Application Publication
(10) Pub. No.: US 2019/0297927 A1
(43) Pub. Date: Oct. 3, 2019

(54) GLUTEN FREE PASTA AND PASTA-LIKE PRODUCTS AND USAGE OF SUCH

(71) Applicants: World Food Holdings, LLC, Oskaloosa, IA (US); Puris Proteins, LLC, Oskaloosa, IA (US)

(72) Inventors: DAKOTA R. NOVAK, Forest Lake, MN (US); KUSHAL NARAYAN CHANDAK, St. Louis Park, MN (US); ALEXANDER EDWARD KING, Apple Valley, MN (US); NICOLE ANN ATCHISON, Eden Prairie, MN (US)

(21) Appl. No.: 16/292,833

(22) Filed: Mar. 5, 2019

Related U.S. Application Data
(60) Provisional application No. 62/651,760, filed on Apr. 3, 2018.

(51) Int. Cl. A23L 11/00; A23L 7/113; A21D 13/045; A21D 13/066; A21D 2/36

(52) U.S. Cl. CPC A23L 11/05; A23L 7/113; A23V 2002/00; A21D 13/066; A21D 2/362; A21D 13/045

(57) ABSTRACT

The present disclosure relates to a unique combination of pulse (i.e., non-soybean, non-peanut legumes) ingredients that create versatile gluten free pasta and pasta-like products with consumer desired nutritional content, clean label, and finished product texture characteristics. In particular, the gluten free pasta products of this disclosure have the flavor and texture expected of wheat based traditional pasta without the need for wheat gluten, egg protein, dairy proteins, hydrocolloids, oil, or other non-pulse ingredient addition. In particular, the gluten free pasta-like products of this disclosure have the protein content and finished product texture characteristics consumers' desire. These products include crunchy snacks, chewy meat and dairy analogs, and environmental friendly film and molded packaging products.

### CROSS-REFERENCE TO RELATED APPLICATIONS

The application claims the benefit of U.S. Provisional Patent Application No. 62/651,760, filed Apr. 3, 2018, entitled “Gluten Free Pasta Composition and Usage of Such”, which is hereby incorporated by reference in its entirety as if fully restated herein.

### BACKGROUND

Pasta is a plant based product made using heat and shear to create at least some alignment of carbohydrate and protein molecules. This includes products commonly known to consumers as “pasta”, that is rotini, mostaccioli, noodles, and such. This also includes products known to consumers as puffed or expanded snacks and cereal, as meat and cheese analogs, as chewy sweet products, and as starch based films.

Under these definitions, pasta product (which includes but is not limited to noodles, macaroni, ganache, and dumplings), is traditionally made from wheat flour (possibly with additional flours) that is mixed with water and optionally with additional ingredients (such as eggs, salt, oil, flavors, colors, vegetable powder, fruit powder, and combinations of such) to make a dough mass that is then extruded into shapes or sheeted and cut into shapes. The pasta dough pieces can be immediately cooked in boiling water and then consumed as “fresh” pasta. Alternatively the pasta dough pieces can be dried into pasta product, which would be cooked in boiling water at a later time at the convenience of consumer or manufacturer. The pasta dough pieces are usually dried after shaping or cutting, and then later cooked with an excess of boiling water before being consumed. These products are often labeled by their shapes (e.g., rotini, spaghetti, elbow macaroni). Sometimes the pasta is placed into retortable containers, either dry, partially cooked, or fully cooked, along with water and additional ingredients, and then cooked at high heats and/or pressure (i.e., retorted or canned) to make soups or meals.

Under these definitions, pasta-like products (which includes but is not limited to puffs, RTE [Ready-to-Eat] cereal, extruded snacks, texturized protein products, mean analogs, dairy analogs, and flexible films and molded products) are traditionally made from wheat flour or soybean flour (possibly with additional flours) that is mixed with water and optionally with additional ingredients (such as eggs, salt, oil, flavors, colors, vegetable powders, fruit powders, lipids, emulsifiers, fats, acids, sweeteners and combinations thereof) to make a dough that is extruded (or otherwise mixed, sheared, and heated) into shaped pieces or sheeted or roped. The pasta-like dough pieces can be completely cooked when extruded or can be partially cooked when extruded and then put through additional heat processes after extrusion. The pasta-like dough pieces can be dried, puffed, fried, baked, boiled, broiled, or otherwise heat processed after or during extrusion. The extruded pieces can also be oiled, coated, dusted, sprinkled (such as with sugar or spices), filled, layered, chopped, agglomerated, and any combination thereof. Coatings and fillings can be water based, oil based, fat based, or combinations thereof.

Pasta and pasta-like products are popular with consumers for many reasons. Pasta and pasta-like products, due to their carbohydrate and/or protein content, are an excellent and often inexpensive source of energy. Pasta and pasta-like products can have a taste and texture that is appreciated and expected by many consumers. The texture can be created such that it could be described as firm (i.e., there is resistance when first bitten into), as crunchy (i.e., has an audio and a tactile sensory characteristic based on how it breaks up as chewed), as elastic (i.e., has a spring, or give when bitten into and chewed), and as cohesive (i.e., feels like it is holding together when chewed, or is not fast dissolving when chewed). Pasta and pasta-like products also have a creative or artistic factor in that they can be made into many different shapes and can be colored and flavored with a wide variety of ingredients. Pasta-like products can be formulated and processed to be alternatives to meat products (i.e., meat analogs), to be alternatives to dairy products (i.e., dairy analogs), and to be alternatives to egg white products (i.e., egg white analogs). Pasta and pasta-like products can also be made with layers through lamination, filling, coating and combinations thereof. Pasta-like products can be formulated and processed to be alternatives to traditional coatings or laminates on and in food products.

Pasta products are traditionally made from wheat flour. Strictly speaking, noodles and macaroni fall under the present 21 CFR Part 139, which generally requires that noodles and macaroni be made at least partly from wheat flour. Pasta does not have a CFR standard of identity, though pasta is often also based on wheat flour. Pasta-like products do not have a CFR standard of identity. Usually pasta-like products are also often made with wheat flour because of the benefits of the gluten proteins during extrusion, or with soybean flour because of the benefits of the soybean proteins during extrusion.

Wheat flour contains wheat gluten, which is actually a combination of two proteins: glutenin and glaiadin. These two proteins are also found in rye, spelt, and barley, though they are highest amount in wheat. When wheat flour is mixed with water, the glutenin and gliadan intermesh with each other and become a sticky protein mass. This sticky protein mass is what gives wheat based flour dough its elasticity and cohesion.

Wheat gluten gives pasta and pasta-like products their characteristic textures of firmness, brittleness, crunchiness, elasticity, chewiness, cohesiveness, and combinations thereof. Wheat gluten also holds together the flour containing mass during heating (with and without excess water). Ideally, when pasta and pasta-like products are cooked in heated water or oil, the water or oil remains clear and free of solids. Texture and appearance stability is very important for the current consumers who want prepared products or who want products they can prepare ahead of time and store for convenient later use. To give wheat based pasta and pasta-like products the strength to withstand destruction in high temperature and/or pressure cooking systems (e.g., frying or retorting), extra protein can be added to the wheat based pasta dough. Often, this added protein is egg white, that is, egg albumin. Some wheat based pasta and pasta-like products contain hydrocolloid gums, such as guar, locust bean, carrageenan, or xanthan gum, to strengthen pasta and pasta-like product structure.

There is a growing consumer trend towards food products with no gluten content. Many consumers have, or believe they might have, celiac disease. Celiac disease is a chronic digestive disorder resulting from an immune reaction to glaidin. This involves inflammation and destruction of the inner lining of the small intestine, which can lead to the malabsorption of minerals and nutrients. Such a disease brings on symptoms that include gastro irritation when products containing gluten are consumed. For this reason, there is a growing interest by consumers for pasta products with the texture and flavor they expect with traditional pasta products (made with wheat flour) to be made without wheat gluten.

There is also a growing consumer trend against food products containing allergens besides wheat gluten. The top eight allergens presently according to FDA include: wheat, soy, milk, eggs, fish, crustacean shellfish, tree nuts, and peanuts; the inclusion of any of these allergens requires such content (or even possible content) on product labels.

Consumers on vegan diets (also called plant based diets) are interested in avoiding food products that contain animal based proteins, which include proteins from egg, meat (including gelatin), and milk sources. The avoidance of gelatin containing products by some consumers can also be attributed to religious dietary laws, as its source is usually from meat (especially pork). Gelatin from fish might meet religious dietary laws, but is avoided because of its usual “fishy” flavor notes. As proteins provide the means for absorbing and maintaining water content with a wide range of food products (including pasta products), the lack of the use of these traditional proteins often creates product defects such as too soft texture and too poor volume (e.g., bulk for chewing).

There is a growing consumer trend in clean label food products. Consumers are growing more cautious on what they eat. As such, there is a growing trend for consumers to read labels before they try food products. This means inclusion in ingredient statements or on label panels of no ingredients that sound synthetic or highly manufactures (such as emulsifiers, surfactants, and hydrocolloids), nor of ingredients that would unexpected (such as hydrocolloids, colors, dies, artificial flavors and colors). Clean label also means using non-GMO, natural, and/or Organic certified ingredients. With more and more detail being placed on restaurant menus and publicity, manufacturers are getting as cautious with what they deliver to the consumer.

There is a growing consumer desire for products that are non-GMO. Many consumers desire that ingredients used to make their pasta and pasta-like products are non-GMO according to Non-GMO Project Verified (nongmoproject.org) and by FDA regulations. Consumers also often desire the products they consume to be Organic Certified by USDA.

Non-GMO means not genetically modified. Non-GMO Project Verified (nongmoproject.org) program has rules to assure that foods labeled with Non-GMO Project Verified trademark contain ingredients that have been proven to be non-GMO. FDA.gov website currently includes guidance for manufacturers who wish to voluntarily label food as containing or not-containing genetically engineered ingredients. Additional label regulations as to mandatory labeling or foods containing genetically engineered ingredients are being developed for enforcement starting roughly 2020. Under these regulations, traditional breeding of pulse plants would be free of genetic engineering.

Organic certification means that the products with the USDA Organic trademark have been made with ingredients and processed according to rules set by USDA regulations. Organic certification will not be given to products with GMO ingredients.

There is also a growing consumer trend (and so also a manufacturer trend) towards more nutritious food products, which match the forms the consumers are familiar with (such as pasta and pasta-like products). There are a range of categories under the umbrella of “nutritious”, two of particular interest to consumers for pasta and pasta-like products that are high in dietary fiber and high in protein. Making high fiber and high protein containing pasta and pasta-like products is also a growing trend for restaurateurs and the manufacturers who supply to restaurateurs.

Consumer trends have shown a growing interest and belief in the need for increased fiber in their diets, especially fiber that tastes good and delivers desirable texture to food products.

The gluten free pasta and pasta-like products of this disclosure contain components of pulses (preferably peas, chickpeas, and combination thereof). Pulses are non-soybean, non-peanut legumes. Pulses include, but are not limited to, peas, beans, lentils, and chickpeas. As used herein, “pea” means the mostly small spherical seed of the pod fruit Pisum sativum. In particular, the pea used in this disclosure is from varieties of the species typically called field peas, yellow peas, or wrinkled peas that are grown to produce dry peas that are shelled from the mature pod. Peas have been harvested as human food as far back as the early third century BC. Peas are traditional foods in the diets of people living on every continent, most particularly in European, Asian, North African and North American countries. Though traditionally a cool-season crop, new varieties have been breed that can be grown in hotter climates and also in dryer climates. Peas also have been breed to contain a range of physiological characteristics. These breeding practices, as well as the cultural eating histories of so many people, make peas an excellent source for protein and fiber for many consumers world-wide.

Peas as traditionally harvested and dried, have a hull portion (about 6-10% dwt. of whole pea) and a seed portion (about 90-94% dwt of whole pea). When the hull is removed the content of the resulting material includes mostly fiber, but also some protein and starch. The hull portion of the pea may be removed from the whole pea by a number of processes, which can be done by various methods known in the art. These methods include, but are not limited to dry and wet milling. The pea fiber product of this disclosure is not limited by the specific amount of fiber in the variety of peas used in the manufacture of the pea fiber product of this disclosure.

Many terms can be used to describe the sensorial properties of pasta and pasta-like products. In this specification and claims, the term firm texture means that there is resistance when the pasta or pasta-like product is first bitten into. An elastic texture herein means the pasta or pasta-like product has a spring, or elasticity, when chewed. A cohesive texture herein means that when the pasta or pasta-like product is chewed, the product mass feels like it is holding together and not fast dissolving when chewed. A crunchy texture herein means that when a pasta-like product is chewed, there is both an audio and tactile sensorial experience as the product breaks and falls apart into pieces as it is chewed. A more crunchy texture is when there is a louder audio sensorial effect and there are more pieces resulting when the product fractures during chewing (such as with a hard and brittle product).

Pulses (legumes which are non-soybeans and non-peanuts) are excellent sources for starch, protein, and fiber. Unlike soybeans, peas (and other pulses) are not allergens, do not cause digestive problems, and have little if any objectionable flavor. Consumers are looking for meatless alternative protein food products, which are not allergens. Pulse proteins have been used in many consumer products as protein alternatives for gluten, animal, milk, and soybean based proteins. The pasta and pasta-like products which are embodiments of this disclosure contain protein in levels that can be adjusted to contain the protein content desired by consumers. In pasta products such a protein range could be, but is not limited to, from less than or equal to 12 dwt. % protein to more than or equal to 25 dwt. % protein as in some of the examples of gluten free pasta of this disclosure. In pasta-like products such a level of protein could be, but is not limited to, 10-25% in examples of pasta-like products that include but are not limited to RTE cereals and extruded snacks. But also, in other pasta-like products that include, but are not limited to, texturized plant protein, meat analogs, and cheese analogs, where in the protein level could be, but is not limited to, 50-90%.

High protein diets have been shown to have a number of health benefits, including but not limited to, aid in maintaining weight, aid in stabilizing blood sugar levels, and aid in ability to learn and concentrate. High levels of protein in foods also lead to satiation at lower calorie content. Protein is the building blocks for both bone and muscles, and as such, protein is important to every cell in the body.

A natural ingredient to partner with pulse protein is pulse fiber. Pulse fiber has the ability to work in gluten free products by giving the products water absorption and water maintenance that gluten usually performs in wheat based pasta products.

Fiber has been defined to be the components of plants that resist human digestive enzymes, a definition that includes lignin and polysaccharides. These digestible enzyme cannot split the glycosidic bonds and the fiber moves through the digestive system to the large intestine. Chemically, fiber consists of non-starch polysaccharides such as cellulose, pectin, lignin and oligosaccharides.

Such fiber can be measured according to AOAC method 991.43. An added benefit of the use of the pulse fiber product used in embodiments of this disclosure is the ability to claim the fiber as “dietary fiber” under 21 CFR sect. 101.9 (c)(6)(i) as the fiber content of the pulse fiber product used in embodiments of this disclosure is derived from the hull or interior of the pulse without chemical synthesis or chemical separation. Another added benefit of the use of the pulse fiber product used in embodiments of this disclosure is its slightly toasted, nutty flavor, as well as the absence of a “pea” or “beany” flavor often present in byproducts of legume manufactured materials.

Dietary fibers can act by changing the nature of the contents of the gastrointestinal tract and by changing how other nutrients and chemicals are absorbed. Some types of soluble fiber absorb water to become a viscous substance that is fermented by bacteria in the digestive tract. Some types of insoluble fiber have bulking action and are not fermented. Lignin, a major dietary fiber source, may alter the rate of metabolism of soluble fibers. Other types of insoluble fiber are fully fermented. Some but not all soluble plant fibers block intestinal mucosal adherence and translocation of potentially pathogenic bacteria and may therefore modulate intestinal inflammation, an effect that has been termed caotrabiotic.

Consuming fiber may result in the production of healthful compounds during the fermentation of soluble fiber, and insoluble fiber's ability (via its hygroscopic properties) to increase bulk, soften stool, and shorten transit time through the intestinal tract. Fiber supplements have been used by consumers for managing irritable bowel syndrome.

Though all plants contain some fiber, the means by which that fiber is separated from the plant and further processed effects the functionality of the resulting fiber material. Pulses contain fiber both in their hull (outer portion) and in their seed (inner portion). The pulse fiber product used in embodiments of this disclosure would be defined as dietary fiber under FDA (21 CFR sect. 101.9 (c) (6) (i) as it is “intact and intrinsic”, that is, in its natural state. Pulse fiber material (especially the hull sourced pulse fiber) would be similar to the “bran” example used by the FDA as an example of plant fiber that is “intact and intrinsic”. The pulse fiber that is from the interior of the pulse may also be labeled as dietary fiber according to FDA, as the pulse fiber falls within the definition of “cell wall materials”, which has been shown to have medical benefits.

Another natural ingredient to partner with pulse protein is pulse starch. Pulse starch adds bulk and binding to pasta and pasta-like products, as well as being an excellent energy source.

Consumers and manufacturers are always looking for ingredients and ratios of such that will allow them to creatively make a range of finished products. These finished consumer products typically should have the taste and texture characteristics familiar to consumers, and yet meet their nutritional and labeling requirements. Wheat flour (with its gluten protein, starch, and fiber content), soy flour (with its protein, starch, and fiber content), eggs (with its albumin protein content), and milk (with its casein and whey protein content) have been used to make a range of pasta and pasta-like products of different sensorial characteristics. All of these products include ingredients on the FDA allergen list because there are many consumers with health issues after eating these products. So there is a need by consumers (and manufacturers who produce products for consumers) for gluten free alternatives for consumption as is or as part of side dishes, entrees, breakfast foods, desserts, and snacks. Consumers are looking for creative sources of basic food products that meet their nutritional and labeling needs. The problem is creating gluten free pasta and pasta-like products with the desired nutritional and labeling requirements, and with the desired texture and taste consumers want.

With pasta products, there are some commercial legume based pastas available, but they do not have a too soft first bite, low elasticity, and poor cohesion when compared to traditional pasta made with wheat flour. These commercially available pasta products also have considerable structure breakdown during cooking, causing loss of solids into the cooking water (i.e., slough-off), which is an irritation for both consumers cooking these products at home and for restaurateurs preparing the product for consumers

With pasta-like products, there are some commercial wheat free pasta-like products available, but they often have too soft or too hard first bite, as well as distinct flavor from the ingredients (often soybean flour) they are made from that is not part of their desired product flavor profile.

Another category of pasta-like products is flexible (also called “plastic”) products made with carbohydrates (including isolated starch, isolated fiber, flour, and combinations thereof), optionally with proteins, also called “bioplastics”. Because of the long polymer structure of many carbohydrates, such carbohydrates can be processed in such a way as to produce gels and/or films that can be made into sheets, ropes, or molded pieces. Utilizing carbohydrates to make flexible products allows for products made with renewable resources and that are biodegradable, unlike petroleum based flexible products.

Therefore, there is need for gluten free pasta and pasta-like products and processes, and a need for these in connection with consumer and manufacturer desired texture, taste, nutrition, and labeling.

### SUMMARY

The disclosure below uses different embodiments to teach the broader principles with respect to compositions, articles of manufacture, apparatuses, processes for using them and apparatuses, processes for making them, and products produced by the process of making, along with necessary intermediates. This Summary is provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

With the foregoing in mind, please consider that the present disclosure is broadly concerned with a gluten free pasta and pasta-like products that are nutritious, palatable, and gluten free, as well as optionally high in fiber and protein. “Gluten free,” “no gluten,” “free of gluten,” or “without gluten” in some cases must contain less than 20 parts per million (ppm) of gluten. In some cases too, besides the limit of gluten to 20 ppm, there often is the added requirements that the food does not contain:
An ingredient that is any type of wheat, rye, barley, or crossbreeds of these grains,
An ingredient derived from these grains that has not been processed to remove gluten, or,
an ingredient derived from these grains that has been processed to remove gluten, but results in the food containing more than 20 ppm of gluten
   Depending on the embodiment of interest, the composition be a composition of less than 20 ppm of gluten, of less than 20 ppm of gluten with the added requirements mentioned above, consisting essentially of no gluten, or consisting of no gluten.

The gluten free pasta and pasta-like products can be used to make food products with the texture and flavor desired by consumers, while meeting the consumer's nutritional wants and needs. The disclosure is primarily, but not exclusively, concerned with gluten free pasta and pasta-like products that can be consumed alone or in a composite food, such as savory salads, side dishes (such as pasta with cheese sauce), soups, entrees, breakfast foods, desserts, and snacks. Preferably, the gluten free pasta and pasta-like products contain the starch, fiber, protein, flour and combinations thereof from pulses. The pulses can, but need not always, be peas, chickpeas, and combinations thereof.

The present disclosure relates to a combination of pulse (i.e., non-soybean, non-peanut legumes) ingredients that create versatile gluten free pasta and pasta-like products with consumer desired nutritional content, clean label, and finished product texture characteristics. In particular, the gluten free pasta product of this disclosure has the flavor and texture expected of wheat based traditional pasta (i.e., noodle or macaroni products) without the need for wheat gluten, egg protein, dairy proteins, hydrocolloids, oil, or other non-pulse ingredient addition. The composition of the gluten free pasta product of embodiments of this disclosure comprises 50-95 dwt. % pulse carbohydrate, 5-50 dwt. % pulse protein, and less than 6 dwt. % fat. Preferably, the gluten free pasta product of the current disclosure comprises 8-28 dwt. % pulse fiber and 30-90 dwt. % starch. The pea starch in the gluten free pasta product of this disclosure could be in isolated form (raw or at least partially precooked) or as part of other pulse materials.

The pasta-like product embodiments of this disclosure have a protein content of, but is not limited to, 5-25 dwt. % in examples of pasta-like products that include but are not limited to RTE cereals and extruded snacks. Other pasta-like product embodiments of this disclosure have a protein content of, but is not limited to 50-90 dwt. % in examples of pasta-like products that include but are not limited to texturized plant protein, meat analogs, cheese analogs, films, and molded products. The pasta-like product embodiments of this disclosure have a starch and/or fiber (i.e., carbohydrate) content of 90-10 dwt. %.

### DETAILED DESCRIPTION

This disclosure describes a unique combination of pulse (i.e., non-soybean, non-peanut legumes) ingredients (preferably pea, chickpea, and combinations thereof) that, when processed with shear, heat, and water, create versatile gluten free pasta and pasta-like products with consumer desired nutritional content, clean label, and finished product flavor and texture characteristics. The resulting gluten free pasta and pasta-like products of embodiments of the current disclosure contain components of pulses including protein, starch, fiber, flour and combinations thereof.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Today's consumer desires traditional food products with traditional textures and flavors, while having clean labels with no gluten and no chemical emulsifiers or elastomers. The challenge for food product manufacturers is to discover a material that can be used efficiently in this broad range of commercial food products. A unique combination of pulse ingredients that, when processed with shear, heat, and water create versatile gluten free pasta and pasta-like products with consumers' desired textures and flavors is disclosed herein.

The gluten free pasta and pasta-like products of embodiments of the current disclosure, could be made using isolated and purified fiber, starch, and protein pulse materials, and could be made with whole pulse flours, pulse isolates, other portions derived from milling pulse seeds, and combinations thereof. The Examples given are illustrations of pasta and pasta-like products of embodiments of the current disclosure containing non-isolated pulse materials, isolated pulse materials, or combinations thereof, which were chosen to meet the proximate dwt. % of protein, starch, carbohydrate, and fiber desired by consumers in the final food products (i.e., pasta and pasta-like products).

The composition of the gluten free pasta product of embodiments of the current disclosure comprises 50-95 dwt. % pulse carbohydrate, 5-50 dwt. % pulse protein, and less than 6 dwt. % fat. Preferably, the gluten free pasta product of the current disclosure comprises 8-28 dwt. % pulse fiber and 30-90 dwt. % starch. The composition of the gluten free pasta-like product of embodiments of the current disclosure comprises 10-90% protein, up to 30% starch, and up to 30% fiber. The pasta-like products of embodiments of the current disclosure disclosure have hard and crunchy expanded textures or flexible non-expanded textures, depending on their content and process conditions.

Pasta-like products of embodiments of the current disclosure with a level of protein 5-25 dwt. % often have a crunchy texture and include, but are not limited to, RTE cereals and extruded snacks. Other pasta-like products of embodiments of the current disclosure with a level of protein from 50-90 dwt. % protein include, but are not limited to, texturized plant protein, meat analogs and cheese analogs.

The pea starch in the gluten free pasta and pasta-like products of embodiments of the current disclosure could be in isolated form (raw or at least partially precooked) or as part of other pulse materials. Pulse starch (especially pea starch) has a unique composition in that it contains high amylose content, which allows this starch to be surprisingly helpful in creating pasta and pasta-like products with ideal and preferred texture. In theory, the amylose molecular chains of glucose under certain process conditions can align and network with each other to create a matrix or gel. The matrix or gel structure can trap other molecules (such as protein) when the conditions are desirous. Also in theory, the pulse starch amylopectin chains of glucose units are very branched and can bond and trap water molecules within its structure. In pasta and pasta-like products, the pulse starch (especially pea starch) structure could in theory aid in making the resulting pasta and pasta-like products stronger and more resistant to chewing (i.e., aiding firmer bite, more elasticity, and greater cohesion) as well as stronger and more resistant to effects of heat in excess water, such as cooking in boiling water, retorts, or canners; or cooking in excess oil, such as in frying.

A key to the functionality of these pulse ingredients is how the ingredients are combined and with what stress, heat, and shear is applied to them. Pulse proteins, starches, and fiber ingredients can be flexible or rigid based on the amount of shear applied, as well as moisture, amount of non-moisture fluids, and amount of solids present at the time of shear application.

An extruder is any piece of equipment that can mix wet and dry ingredients under heat and shear conditions. Such a piece of equipment would have at least one entrance port, a chamber for mixing and applying shear, and an exit port, which may also apply shear. Preferably, the extruder used to make the pasta and pasta-like products of the embodiments of the current disclosure allows controlled addition of ingredients and controlled mixing and shear application, as well as controlled heating of the ingredients. The shear would be applied within the extruder as well as optionally applied as the ingredient mass (i.e., dough) exits the extruder, such as through a die at the exit port of the extruder. The extruder could be mounted horizontally or vertically. Entry of ingredients into the equipment could be at one point or at several points. The mixing in the equipment could be done by elements on a shaft located along the interior longitudinal center of the equipment. The elements could be altered in design and placement to create the desired shear during mixing and heating. The elements could also convey the ingredients from their entry point(s) to the exit point. The exit point of the extruder could include mechanisms to create more heat and shear to the dough as it exits the extruder. External to these exit mechanisms could be additional equipment mechanisms to cut, shape, coat or combinations thereof the rope, ribbon, sheet, or film of extruded ingredients (i.e., dough). Food product designers could develop an extruder and its related mechanisms at extruder exit port to create the end product desired from a dough, if that dough contains the relevant ingredients at the relevant content levels. Conditions post extruder exit port could be controlled so that the exiting dough could be heated or cooled so as to effect the expansion of the dough as it exits the extruder. Also, means for heating or cooling the dough could be available post extruder, such as, but not limited to, a heat lamp, oven, oil fryer, forced air applier, chilling chamber, or spiral freezer.

A factor effecting the mixing, heating, and shearing of the ingredients in the extruder and as the ingredients exit the extruder is pressure. The conditions within the extruder and at the exit port of the extruder, can create pressure on and in the dough within the extruder. The difference in pressure before the extruder exit die and after the extruder exit die (i.e., immediately outside the extruder) can greatly affect the sensorial character of the dough after it exits the extruder. If there is more pressure on the inside of the extruder side of the exit port than on the outside of the exit port (and die), then the dough will expand when passing through the die to exit the extruder due to volatiles expanding under the reduced pressure. If the dough temperature is high enough within the extruder, then the water content of the dough will expand as the dough exits the extruder and die and the water vaporizes under the lower outside pressure. If the dough temperature is high enough within the extruder, then some ingredients in the dough will expand with the expanding water/vapor when the dough exits the extruder and die. If the dough includes any injected gasses (such as carbon dioxide) or if the dough includes ingredients that can cause gas formation (such as acids and bases), then the dough will expand when it exits the extruder and die as the gasses expand under the reduced pressure.

A pressure difference between extruder interior and exterior could be also caused by the mixing within the extruder forcing build-up of dough mass against the exit port, as well as mixing that forces the dough mass to exit the extruder through a size reduced exit port and/or die.

The amount of expansion of the dough as it exits an extruder and die is also dependent on the nonvolatile ingredients in the dough. Some ingredients will melt or become more flexible under the heat and/or shear within an extruder. These melted or more flexible ingredients could stay melted and more flexible when they exit the extruder and die, or they may become solid or less flexible. The higher the energy imparted to the ingredients within the extruder (either by heating, shearing or higher pressure application) the more likely ingredients such as starches, fibers, and proteins will “melt” that is, change from a harder/more firm texture to a more fluid texture. When these materials exit the extruder and die, these ingredients can become firmer as the applied energy dissipates. Manipulation of the energy within an extruder and the contents of the dough can lead to expanded dough that is hard and brittle or chewy and flexible. This allows the extruder to be used with pulse ingredients to produce hard finished dough products (such as pasta-like products, including but not limited to crunchy snacks and RTE cereals) and to produce flexible dough products (such as pasta and pasta-like products, including but not limited to texturized proteins, meat and dairy analogs, chewy sweet goods, and starch based plastics). Flexible dough products can also be described as “plastic” in that they are dough products with enough flexibility to be useful in making molded, sheeted, roped, and/or layered products.

The process for making the gluten-free pasta and pasta-like products of the embodiments of the current disclosure is not limited by the process or equipment mentioned in this disclosure, but can be any process and equipment that is available to a product developer or a manufacturer, providing the process and equipment allow that mixing, shearing, heating, and pressure building characteristics that are desired in this disclosure as for creating the finished pasta and pasta-like product texture characteristics.

When there is a pressure decrease on a dough as it leaves the extruder and the mechanisms on the exit point (i.e., port), the liquids within the dough will expand upon exit and then contract as the extruded dough cools and equates to the external pressure. The higher the temperature of the dough within the extruder, followed by a lower temperature external to the extruder, the greater the expansion and then contraction upon exiting the extruder. If gas (e.g., CO₂, N₂, air) is pumped into the dough in the extruder, then that gas would also expand as the dough leaves the extruder and any mechanisms at the exit port of the extruder. This would also occur if the gas is created chemically while the dough is in the extruder, such as by addition of acid and base ingredients. As the gasses expand upon exiting, the solis mass of the dough also expands. When the gasses cool, the expanded dough structure contracts. Contraction can lead to a more hard and brittle end product than if there was no expansion. Specific ingredients can be added to physically block the expansion and/or the contraction of the dough. These specific ingredients are added to cause blockage or lubrication of the dough ingredients.

Fiber can physically interfere with protein and starch molecules aligning and crystallizing. Fiber can also create its own physical matrix. Lipids, fats, and emulsifiers can be added to a dough to add lubrication to that dough as the dough expands and then contracts after exiting the extruder exit port. These materials interfere with bonding between starch and protein molecules within the dough and allow starch and protein molecules to “slide” and “slip” past each other without bonding to each other during expansion and/or contraction. Fiber can lubricate dough with similar functionality. Fiber can lubricate dough during expansion and after the dough adjusts to temperature and pressure outside the extruder by assisting in keeping water within the dough. Fiber can absorb water, while not gelatinizing like starch and not denaturing like protein. Under certain extrusion conditions, fiber can also encase or coat the extruded material's surface, which traps moisture and other volatiles within the extruded dough and creates more flexible finished extruded dough product.

Whether a dough maintains its post extrusion geometry is heavily dependent on the contents of the dough when it exits the extruder exit port die and the physical conditions within and outside the extruder exit port, as already discussed. Ideally, the final rigid or flexible dough product has the sensorial characteristics desired by consumers. These sensorial characteristics are dependent on the use of the final dough product consumed.

For pasta product embodiments of the current disclosure, levels of pulse (preferably pea, chickpea, and combinations thereof) protein, starch, and water created cooked pasta product with good chewing texture and good integrity during cooking. The extruder conditions for these pasta product embodiments of the current disclosure were such that the dough ingredients were mixed well enough to create protein and starch matrixes that gave the finished pasta its strength during cooking in excess water and its desirous eating texture (fresh and after storage). This was true for pasta dough formulations that also included fiber ingredient. For some pasta product embodiments of the current disclosure, there was a small difference in the pressure on the dough between when the dough was in the extruder and after it exited the extruder and any mechanisms at the exit port of the extruder. For some pasta product embodiments of the current disclosure there was a significant reduction in the external pressure relative to the internal pressure, and the resulting pasta products were less dense due to expansion. An expansion would create a quicker hydrating (i.e., cooking) pasta finished product, such as that desired for microwaveable meals with dry or semi-hydrated components.

In embodiments of the current disclosure, pasta products that are not expanded include, but are not limited to noodles of various shapes including but not limited to ropes, sheets, ribbons, balls, ovoids, pillows, twists, tubes, shells, pockets (e.g., tortellini, ravioli), and combinations thereof.

In embodiments of the current disclosure, pasta expanded and not expanded finished consumer products include, but are not limited to, pasta products that are softened during their cooking with water and are flexible, cohesive, and have a firm bite when consumed in their hydrated form. By flexible, it is meant that there is chewy, flexible, bendable, elastic, springy, or plastic sensorial character to the finished product. By cohesion, it is meant that the product remains a mass (though possibly with softening as saliva combines with the product) during mastication (i.e., chewing). A chewy product has a lot of cohesion. If a product does not have cohesion, the product breaks into noticeable pieces of mass in the mouth during mastication. By firm bite, it is meant that there is resistance to the teeth biting through the product. In embodiments of the current disclosure, pasta product can utilize some expansion upon exiting an extruder that would allow for quicker hydration during cooking in water that would be useful for pasta used in microwave heated side-dishes and entrees.

In embodiments of the current disclosure, pasta-like non-expanded finished consumer products that are flexible and/or plastic (i.e., material that is malleable, moldable, sheetable, bendable, laminatable, ropeable) include, but are not limited to, products such as texturized protein, texturized starch, meat analogs, dairy analogs, egg analogs, chewy confections, deposited confections, molded and/or sheeted flexible coating or “packaging” products, and combinations thereof.

In embodiments of the current disclosure, pasta-like expanded finished consumer products include, but are not limited to, crunchy and brittle food products often labeled by manufacturers, marketers, and consumers as puffs, pillows, crisps, chips, crunchers, RTE breakfast cereal, inclusions (such as used with yogurts, ice cream, and cookies), particulates, and other pasta-like products that have a crunchy and brittle texture when consumed as is or in snacks, side-dishes, desserts, or entrees. By crunchy, it is meant that there is both an audio and a tactile sensory characteristics when chewed. By brittle, it is meant that there is a hard tactile sensory characteristic when bitten. In embodiments of the current disclosure, pasta-like expanded finished consumer products that are flexible or not flexible include, but are not limited to, products that are solid foam or foam-like products, such as aerated shipping “peanuts” or “loose fill” packing material pieces.

The pasta and pasta-like embodiments of the current disclosure can have ratios of pulse (preferably pea, chickpea, and combinations thereof) based protein, starch, fiber and flour ingredients shifted to create a range of different textures desired by consumers. These resulting textures can make the pasta and pasta-like products harder or softer, more or less brittle, and more or less chewy, flexible and cohesive.

With pasta product embodiments of the current disclosure dough ratios of protein, starch and fiber ingredients were chosen so that the resulting pasta product, when further heated with excess water, had the consumer desired elasticity, cohesion and firm bite. As with the pasta-like embodiments, the pulse (preferably pea, chickpea, and combinations thereof) based protein, starch, and fiber ingredient ratio is chosen to create a series of ingredient matrixes that when hydrated will create the desired flexible structures needed to give elasticity, cohesion, and firm bite during chewing. A challenge is that, depending on the embodiment, there are ingredient ratios to create a pasta product structure that will not lose ingredients into the cooking water when the pasta products are cooked in boiling water. This would also be true if the products are fried in excess oil. However, certain ratios of pulse based ingredients create pasta-like expanded products with better shelf-life and/or bowl life because they were stable against absorption of water from the environment they are stored in. Bowl life describes the ability of a pasta-like product to maintain a crunchy texture while surrounded by water and/or milk (for example, with RTE breakfast cereals) or while surrounded by water, milk, and/or cream (for example, with inclusions in yogurts or ice cream) or while sitting on a wet surface (for example, with particulates used as topping on iced bakery products, on intermediate moisture desserts and entrees, and on high moisture dairy products such as yogurt or ice cream).

Many pasta-like products that are embodiments of this disclosure are extruded pulse based dough that is made hard and crunchy when the extruded dough is placed in boiling oil or placed into ovens. These post extruder products can expand as the moisture content of the dough heats and expands. This expansion of water can also occur if post extruder dough is placed in a “popper”. In a popper, the dough is treated with a sudden decrease in pressure, which causes instant vaporization of water that leads to instant expansion, or “pop”.

The crunchy aerated texture of pasta-like products of embodiments of the current disclosure is often critical or important to sensorial acceptance of these food products by consumers. This crunchy aerated texture requires an expandable mass with strong air cell wall support that can be fixed (i.e., stabilized) during the expansion and any subsequent heating process. With gluten based products, the gluten protein creates and maintains the air cell structure. The embodiments of the current disclosure describe a combination of pulse ingredients, along with mixing, heating, and shear conditions that would create expanded pasta-like products with crunchy aerated textures acceptable to consumers that have characters similar to those made with gluten. The final product texture of the pulse based pasta-like products of embodiments of this disclosure can be adjusted by pulse protein, pulse fiber, and/or pulse starch content, with or without changes in extruder mixing, shearing, and heating conditions. Not to be limited by theory, but the ability of the pulse based dough to expand is due to the pulse protein content, pulse starch content, as well as optional fiber content. These three ingredients have molecules that can, with water and energy (from shear and/or heat application) create matrixes within the resulting dough that allows for enough elasticity to expand when at least a portion of their water content expands. As the dough expands, the molecules of its ingredients slide past each other and bond with each other to create cell walls strong enough to hold the expanded water vapor (and hold any other gasses included in or created by the dough). These same pulse ingredients can then be combined such that the expanded structure has a limited and controlled collapse post-extruder. The pasta-like embodiments of the current disclosure can have combinations of pulse (preferably chickpea, pea, or combinations thereof) ingredients that form a rigid, non-collapsing structure when the expanded dough reaches a critical or suitable temperature. Not to be limited by theory, but at this temperature at least some of the starch gelatinizes and hardens, and at least some of the protein denatures, coagulates and hardens. Fiber, as already discussed, could affect the expanded protein and starch structure. Fiber could interfere with starch and protein hardening, allowing for maintenance of expansion geometry while creating some tempering of the hardness created as the gelatinize starch and coagulated protein hardens. Fiber can also act as a humectant and capture some of the dough moisture creating a softening of the hardened starch and protein structures. Intermixed matrixes of the starch, protein, and fiber ingredients work to both support the expanded structure of the pasta-like products, but also moderates the structures to allow a desired brittleness and crunchiness without unacceptable excessive hardness. The three ingredients, especially fiber, also allow for some absorption of moisture post extruder without detriment to the pasta-like product texture.

Some forms of pea proteins can also make pulse based pasta products stronger and resistant to solids loss during cooking in boiling water, including retort processing. These include pea peptides, pea solubles, and pea albumin. These pea proteins aid in strengthening the structure of gluten free pasta product by creating a protein matrix within the pasta dough that, in theory, coagulates or hardens into a mesh-like structure binding water while trapping solids within it. These pea proteins can also strengthen the gluten free pasta dough structure so that the structure can maintain solids and texture through several rounds of refrigerated and/or frozen storage. These additional pea proteins could be as much as 60 dwt. % of the full gluten free pasta product.

Embodiments of the current disclosure include pasta-like products that are extruded dough products with little or no expansion after exiting the extruder exit port, that are shaped into various forms including sheets, ropes, ribbons, films, pieces, or combinations thereof, and that are flexible and chewy in texture. A film is a matrix or gel that is in a thin sheet physical form. In an embodiment of the current disclosure these extruded flexible and chewy textured forms could be cut into smaller pieces, layered into laminates, forced into shape molds, or a combination of such. These pasta-like embodiments of this disclosure could be used to create finished products that are flexible before additional heat is applied, and optionally flexible after additional heat is applied. These extruded materials could be called flexible, bendable, malleable, or “plastic” in texture. These embodiments would be based on the same basic ingredients and guided by the same theories as that for the pasta and other pasta-like embodiments. That is, the pulse (preferably pea, chickpea, and combinations thereof) based protein, starch, fiber, and flour ingredients interact with themselves and each other to make matrixes, or gels, that create stable finished product forms. A film is a matrix or gel that is in a sheet form.

Pulse starch (especially pea starch) is a good film former relative to other plant starches due to its high amylose starch content. The long, unbranched amylose starch molecules can create a matrix, or gel, structure in a dough under ideal water content, heat content, and processing conditions (such as that with the use of an extruder). Pulse starch and water, with and without additional ingredients, can create a thin film. The challenge is that the pulse starch film dries, the starch molecules align and contract making the film less flexible unless there other ingredients added to the film dough to interfere with the loss of moisture or with the alignment and contractions of starch molecules. Addition of fiber can extend the amount of time that the starch based film would remain flexible either by interfering with starch retrogradation (i.e., molecular alignment and contraction) and/or by maintaining absorbed water content better than starch alone. Addition of protein could also make the pulse starch based film more flexible due to the native flexible character of protein molecule, due to the physical interference by protein molecules, and due to the native water absorption properties of protein. The addition of fiber to a protein containing pulse starch film could increase flexibility by interfering with denatured protein molecules self-bonding (i.e., coagulating). Added fiber could also form its own matrix within and throughout the pulse starch film matrix. Lubricator ingredients could also be added to a starch film composition. Lubricators, such as glycerin and sugar alcohols, could add to the flexibility of the film by being hygroscopic agents, which maintain moisture within the film. Lubricators, such as glycerin, sugar alcohols, oils, and mon- and di-glycerides could add flexibility to a pulse based film by being long molecules the not more than loosely interact with other film content materials and as such are able to keep starch materials from crystallizing (possibly via physically blocking interactions), protein from coagulating, and/or ingredients otherwise creating stiff formations within film materials. Also, lubricators could be fluid at room temperature. This fluidity could aid a film in maintaining its flexibility by acting as a medium within which other ingredient molecules can move.

Pasta Products

Though traditional pasta (i.e. noodles and macaroni) contains plant based materials (i.e. wheat flour) that include starch, fiber, and protein, the pulse based materials used in this disclosure to have unique benefits that resulted in the creation of pasta with excellent pasta character, both as the pasta is made from raw materials and as the pasta is cooked in water and then immediately or later consumed (such as after refrigerated or frozen storage). In particular, this is true when the pulse is peas. This could be due to peas containing unique ingredients (such as pea starch, which has unusually high levels of amylose) that have unique functional properties (such as gelling properties).

Some commercial pastas are available that contain pulses, such as red lentils and chickpeas. These pastas also contain other, non-pulse, ingredients including non-pulse starches (e.g. tapioca) and hydrocolloids (e.g., xanthan gum). Some also include added proteins, which is not surprising since traditional noodles and macaroni contain eggs or egg whites, as well as wheat flour (which includes wheat protein). These non-pulse ingredients appear to have been added in an effort to hold the wet dough together, to make it flexible, and to also limit slough-off during pasta cooking in boiling water. These added nonpulse ingredients could have also been added in an attempt to make the finished, cooked pasta product elastic and cohesive during chewing, as well as give the pasta product a desired bite (that is, a firm texture when teeth cut through the pasta during chewing).

The pasta of the current disclosure did not need the inclusion of non-pulse materials to give a desirable bite, elasticity, cohesion, and low slough-off during cooking. The pasta of the current disclosure also had excellent texture after refrigerated storage of cooked pasta and excellent texture after refrigerated and frozen storage of cooked pasta.

TABLE 1
Commercial Legume Pasta Contents and Sensory Evaluation

| Brand | Banza | POW | Modern Table |
|---|---|---|---|
| Formula (dwt. % | | | |
| Total Carbohydrates | 56.1 | 62.5 | 67.3 |
| Total Protein | 24.6 | 25 | 20 |
| Total Fat | 6.1 | 1.8 | 0.0 |
| Ingredient Statement: | | | |
| Chickpeas, Tapioca, | X | | |
| Pea Protein, Xanthan | | | |
| Gum | | | |
| Red Lentil Flour, | | X | |
| Organic Quinoa | | | |
| Flour. | | | |
| Red Lentil Flour, | | | X |
| White Rice, Pea | | | |
| Protein | | | |
| Sensory Evaluation: | Strong beany flavor | Different beany | Strong beany flavor |
| Flavor | | flavor than Banza and | like Banza |
| | | Modern Table | |
| Sensory Evaluation: | Very low | Very low | Very low |
| Cohesiveness; | cohesiveness, very | cohesiveness, very | cohesiveness, very |
| Springiness; & | mushy; not springy | mushy (more than | mushy (like Bonza); |
| Hardness | when chewed; not | Banza or MT); not | not springy when |
| | hard, was very soft | springy when chewed | chewed (like Bonza); |
| | | (less springy and | not hard, was very |
| | | softer than Banza and | soft (like Bonza) |
| | | MT) not hard, was | |
| | | very soft | |
| Slough-off | A lot, much more | A lot, much more | A lot, much more |
| | than wheat pasta | than wheat pasta and | than wheat pasta, like |
| | | more than Banza and | Bonza |
| | | Modern Table | |

The descriptive sensory results listed in Table 1 include hardness, springiness (i.e., elasticity, flexibility), and cohesion keeping in mind the texture characteristics of wheat based pasta (Barilla Whole Grain Rotini) [Ingredients: Whole Grain Durum Wheat Flour] (Barilla America Inc., Northbrook, Ill. USA). The other samples in the sensory test were: 1) Banza Rotini [Ingredients: Chickpea, Tapioca, Pea Protein, Xanthan Gum] (Banza, LLC. Detroit, Mich.); 2) POW! Pasta [Rotini] [Ingredient: Red Lentil Flour, Organic Quinoa Flour] (Ancient Harvest, Boulder, Colo.); and 3) Rotini [Ingredients: Red Lentil Flour, White Rice, Pea Protein](Modern Table Meals, Blackfoot, Id.). Slough-off results in Table 1 include the appearance of solids (i.e., slough-off) in cook water after 7 minutes cook in boiling water.) Results were evaluated against wheat based pasta.

These commercial pasta products did not contain allergens and could be a source of protein. These products did not contain pea starch or pea flour (which would contain pea starch). The challenge was in the flavor and texture of these cooked commercial pasta products, as well as in the amount of slough-off during pasta cooking. The pasta of the current disclosure met the allergen criteria, as well as having excellent flavor and texture (i.e., bite, elasticity, cohesion) and reduced slough-off during cooking. The pasta of the current disclosure contained pea starch, both in isolated form and/or as part of pea flour. The pea starch also could have been in a raw, uncooked form or in a precooked form.

The pulse starch used in the pasta product of this disclosure was isolated from pea flour (made by wet milling or dry milling peas) and was in a raw state, or could have been further processed into a precooked state. The further processing was accomplished by various means, preferably by such means that included heating at least some (but not all) of the starch granules to above their gelatinization temperature. This treatment gave the starch more functionality, such as more gelling and more thickening capabilities. In theory, this greater functionality, combined with the high amylose content of pea starch, created a unique functionality that allows the creation of the pulse based gluten free pasta product of the current disclosure.

The pulse starch used in the pasta (and pasta-like) products of this disclosure could be in a raw state in a pulse flour, or isolated from pulse flour. The pulse starch could be in a precooked state (in the isolated form and in the pulse flour form), wherein at least part, but not all, of the starch granules were partially gelatinized. To make such a precooked flour or starch the pulse seed would be wet or dry milled, and then heated to a temperature above the gelatinization temperature of the pulse starch. This treatment would give the starch more functionality, such as more gelling and more thickening capabilities. In theory, this greater functionality, especially if the pulse was pea (which had a high amylose content), created a unique functionality that allowed the creation of the pulse based gluten free pasta product of the current disclosure.

Slough-off is undesirable to both consumers and manufacturers. Slough-off means that solids are being pulled from the pasta product during cooking and being lost in the cook water. This loss of mass is not desirable because consumers and manufacturers using the pasta product want to consume what they are cooking (and paying for). The slough-off is also irritating to consumers and manufacturers because of the need to clean the slough-off from cooking pans and utensils. For consumers and manufacturers using gluten free pasta, slough-off also effects the flavor and texture of the cooked pasta. These effects need to be compensated for in their use in finished product presentations and consumption. As noted in Table 1, the commercial products included in the table had considerable slough-off.

The gluten free pasta product of embodiments of the current disclosure describe what could be used to create improved pasta product without use of allergens (including, but not limited to wheat gluten, egg based products, dairy based products, soy based products, and nut based products), without use of hydrocolloids (including, but not limited to xanthan gum, locust bean gum, cellulose gum products, and pectin), and without use of animal based ingredients (including, but not limited to meat, dairy, gelatin, and albumin proteins).

The resulting gluten free pasta product of the current disclosure contained components of pulses (preferably, but not limited to peas) including protein, starch, fiber, flour and combinations thereof. The composition of the pasta of this disclosure comprised 55-91 dwt. % carbohydrate, 5-40 dwt. % protein, wherein the carbohydrate comprised 49-78% (of total pasta mass) pea starch. Preferably, the pasta of this disclosure comprised 4-57 dwt. % of total starch as isolated starch, most preferably 26-48% of total as isolated pea starch. The composition of the pasta of this disclosure further comprised 10-17 dwt. % fiber, preferably, 9-11 dwt. % fiber. The pasta of this disclosure further comprised 10-40 dwt. % of total as protein, more preferably 10-19 dwt. % as protein. Most preferably, this protein was derived from peas (isolated or as part of pea flour).

Pasta Product Examples

Examples of gluten free pasta products of this current disclosure are presented and discussed in Tables 1-10. All percentages are in dry weight percentages (“dwt %”) unless specified otherwise as total weight (“wt”). These batches of Examples were made with pulse ingredients commercially available by Pulse Proteins, LLC (Minneapolis, Minn.). These ingredients include: Puris™ Whole Chickpea Powder—Raw [CCP-R]; Puris™ Whole Yellow Pea Powder-Raw [CYP-R]; Puris™ Whole Yellow Pea Powder-Gelled [CYP-G]; Puris™ Pea Starch—Raw [PS85]; Puris™ Pea Starch—Pregelled [P585-PG]; Puris™ Pea Hull Fiber—Raw [CYP-RF]; Puris™ Pea 870 [P870]; and Puris™ Pea 870H [P870H].

Bench Pasta Product Examples

Combinations of chickpea and pea based ingredients were explored as the contents for gluten free pasta product. Some commercial products included chickpea flour and so the pasta market would be familiar with pulse ingredients on a pasta ingredient statement. The challenge was combining chickpea flour with other ingredients so as to make an improved cooked product flavor and texture, as well as reduced slough-off during cooking without use of non-pulse ingredients. In some examples of gluten free pasta product embodiments of this disclosure, pea flour was used instead of chickpea flour. All ingredients were pulse protein, fiber, starch, flour, or combinations thereof.

TABLE 2
Bench Formulations, Evaluations, & Decisions (Examples 1B-9 B)

| Number | Formulation | Evaluation Results | Next Steps Decision |
|---|---|---|---|
| 1 Bench | 65% Chickpea Flour- | Ran well. But would | Redone as Example |
| | Raw | prefer a firmer dough | 1, with increase in |
| | 30% Pea Starch- | for extrusion and a | Chickpea Flour Raw |
| | Precook | firmer cooked bite | and decrease in Pea |
| | 5% Pea Fiber-Raw | texture, good | Starch-Raw, changes |
| | | elasticity and | made to possibly give |
| | | cohesion. | pasta more body |
| 2 Bench | 50% Pea Flour- | Ran well. Most soft | Not ran again. Still |
| | Precook | and mushy, least | wanted to explore |
| | 25% Chickpea Flour- | cohesive and least | increased protein, so |
| | Raw | elastic cooked | will retred Pea |
| | 25% Pea Protein (870 | texture. The Pea | Protein 870 in |
| | H) | Protein in 3b created | Example 2. |
| | A little bit of pea | a better cook texture | |
| | fiber added in late in | | |
| | run | | |
| 3 Bench | 45% Pea Flour-Raw | Ran well. More | Redone as Example 2 |
| | 25% Chickpea Flour- | mushy, less cohesive, | with different protein |
| | Raw | less elastic than 1B. | material. |
| | 25% Pea Protein | Better than 2B. Not | |
| | (870) | as mushy, more | |
| | 5% Pea Starch- | cohesive, more | |
| | Precook | elastic than 4B-9B | |
| | | examples. | |
| 4 Bench | 65% Pea Starch Raw | Ran well. For texture: | Redone as Example |
| | 30% Pea Flour- | See 3B comments. | 4, though with more |
| | Precook | The goal was to push | heat and steam used |
| | 5% Pea Fiber-Raw | the amount of pea | in cooking than the |
| | | starch content. | rest of the |
| | | | commercial pasta |
| | | | examples in order to |
| | | | possibly cook the |
| | | | starch in process |
| 5 Bench | 45% Pea Flour- | Ran well. The goal | Redone as Example |
| | Precook | was to push the | 3. |
| | 40% Pea Starch-Raw | amount of pea starch | |
| | 15% Pea Starch- | content. For texture: | |
| | Precook | See 3B comments. | |
| | | Had strong beany | |
| | | taste, though not as | |
| | | much as 6B-9B | |
| 6 Bench | 50% Pea Flour-Raw | Ran well. The goal | Redone as Example |
| | 50% Pea Flour- | was to use only pea | 5. |
| | Precook | flour. Also, this | |
| | | would allow only one | |
| | | ingredient on product | |
| | | label. This would | |
| | | allow pea ingredients, | |
| | | as well as be less | |
| | | expensive than using | |
| | | chickpea flour. For | |
| | | texture: See 3B | |
| | | comments. Strong | |
| | | beany flavor. | |
| 7 Bench | 50% Chickpea Flour- | Ran well. The goal | Not run again. |
| | Raw | was to use only | Texture was not as |
| | 50% Chickpea Flour- | chickpea flour. Also, | good as that of other |
| | Precook | this would allow only | samples in bite, |
| | | one ingredient on | elasticity, and |
| | | product label. For | cohesiveness. This |
| | | texture: See 3B | formula would also |
| | | comments. Had | be more expensive |
| | | strong beany flavor, | than the other |
| | | | formulas. |
| 8 Bench | 70% Pea Flour- | Ran well. The goal | Redone as Example |
| | Precook | was to explore the | 6. |
| | 30% Pea Starch-Raw | use of pea starch with | |
| | | pea flour. For texture: | |
| | | See 3B comments. | |
| | | Had strong beany | |
| | | flavor. | |
| 9 Bench | 70% Chickpea Flour- | Ran well. The goal | Not run. Texture of |
| | Precook | was to explore the | 9B was not better |
| | 30% Pea Starch-Raw | use of pea starch with | than that of 8B, |
| | | chickpea flour. | though 9B would be |
| | | For texture: See 3B | more expensive to |
| | | comments. 9B was | consumers and |
| | | more mushy in | manufacturers |
| | | texture than 8B. Had | |
| | | strong beany flavor. | |

Table 2 includes the formulas for examples 1B-9B of gluten free pasta flour that were embodiments of the current disclosure. The pasta product of this disclosure includes water at a nonlimiting amount. As such, the gluten free pasta of this disclosure could be dry (i.e., less than 15 wt. % water content) or cooked (i.e., more than 15 wt. % water content).

Bench Examples Process and Equipment

The dry ingredients (Table 2: Formula Examples 1B-9 B) were combined in a plastic bag and then poured into a bench top pasta maker (Omcan 13317 PM-IT-0002 Pasta Machine). Water was then poured into the mixture while the mixture was in the pasta machine to create a dough of desirable consistency. Evaluations were made as the nine formulations were made into pasta product and after the pasta product examples were dried and then cooked in boiling water (7 minutes). Table 2 includes the evaluations and the decision next steps. Some water was lost in the processing and in the drying steps before examples were cooked. Final moisture was roughly 11 wt % finished dry pasta product.

Commercial Pasta Product Examples

Combinations of chickpea and pea based ingredients were further explored for gluten free pasta product of embodiments of this disclosure, utilizing the results of the bench formula work (Table 2).

TABLE 3
Commercial Pasta Formulas: Examples 1-6

| Example Formula. | 1 | 2 | 3 | 4 | 5 | 6 |
|---|---|---|---|---|---|---|
| Chickpea Flour- | 67% | 25% | | | | |
| Raw Material | | | | | | |
| dwt. % | | | | | | |
| Pea Flour- | | | | 5% | 50% | |
| Raw Material | | | | | | |
| dwt. % | | | | | | |
| Pea Flour - | | 45% | 45% | 30% | 50% | 70% |
| Precooked | | | | | | |
| Material | | | | | | |
| dwt. % | | | | | | |
| Pea Starch - | | | 40% | 65% | | 30% |
| Raw Material | | | | | | |
| dwt. % | | | | | | |
| Pea Starch - | 30% | 5% | 15% | | | |
| Precooked | | | | | | |
| Material | | | | | | |
| dwt. % | | | | | | |
| Pea Fiber - | 3% | | | | | |
| Raw Material | | | | | | |
| dwt. % | | | | | | |
| Pea 870 | | 25% | | | | |
| Protein | | | | | | |
| Material | | | | | | |
| dwt. % | | | | | | |

Table 3 includes the formulas for Examples 1-6 of gluten free pasta product of embodiments of the current disclosure produced on commercial equipment. The pasta product included the dry (less than 15% water content) and the cooked (more than 15% water content) version of these examples, such as was found before and after the pasta product was cooked in excess water and heat.

TABLE 4
Commercial Pasta Formulas (Total Fat, Carbohydrate,
and Protein Content): Examples 1-6

| Example | 1 | 2 | 3 | 4 | 5 | 6 |
|---|---|---|---|---|---|---|
| Total Fat | 5.2 | 5.2 | 2.1 | 1.0 | 3.2 | 2.1 |
| dwt % | | | | | | |
| Total Carbohydrate | 76.3 | 55.7 | 87.5 | 90.7 | 73.1 | 81.3 |
| dwt % | | | | | | |
| Total Protein | 18.6 | 39.2 | 10.4 | 8.2 | 23.7 | 16.7 |
| dwt. % | | | | | | |

Table 4 includes the dry weight percentages (i.e., dwt. %) of total fat, total carbohydrate, and total protein for each of the example formulas in Table 3.

TABLE 5
Fiber and Starch Content: Examples 1-6

| Formula | 1 | 2 | 3 | 4 | 5 | 6 |
|---|---|---|---|---|---|---|
| Total Fiber | 10.3 | 14.4 | 10.4 | 10.3 | 23.7 | 16.7 |
| dwt. % | | | | | | |
| Total Starch | 66.0 | 41.3 | 77.1 | 80.4 | 49.4 | 64.6 |
| dwt. % | | | | | | |

Table 5 includes the dry weight percentages of total fiber and starch content for each of the examples in Table 3.

Commercial Examples Process and Equipment:

The pasta batch examples were made using a commercial pasta extruder [Demaco Small Scale Pasta Press, Defrancisci Machine Corp.], which had a flour mixing portion with two counter rotating shafts with paddles. The actual extrusion portion contained a single screw to convey material to the die plate and to add shear and pressure to the material (i.e., dough). The die used created a rotini shape. Semolina (wheat flour) was first run (with water) through the commercial pasta extruder for around 30 minutes, at which point the extruder appeared to have a steady temperature and pressure. Then for each Example, a batch of ingredients were preblended and mixed with water in the pasta press/extruder. The mass was conveyed through the extruder and finally forced through a die. Examples 1, 2, 3, 5, & 6 were run in order. Example 4 was run with added steam. Each example was tested for cooked sensory characteristics, water pick-up, and cooked compression. Table 6 and 7 list the processing parameters for the production of Examples 1-6.

TABLE 6
Processing Parameters: Commercial Examples 1-6

| | | | | | | Mixer | | |
|---|---|---|---|---|---|---|---|---|
| | Water in | Water out | Pump Flow | Pump Flow | Dough | Water | Product | Die |
| | Temp | Temp | Rate | Rate | Temp | Temp | Temp | Pressure |
| Example | (° C.) | (° C.) | (mL/min) | (kg/hr) | (° C.) | (° C.) | (° C.) | (PSI) |
| 1 | 78.2 | 77.8 | 356.94 | 22.14 | 37.5 | 73.8 | 64.3 | 1159 |
| 2 | 76.3 | 75.7 | 376.66 | 23.37 | 36.4 | 74 | 68.3 | 1417 |
| 2 | 76.4 | 75.6 | 397.92 | 24.68 | 35.6 | 72.9 | 70.2 | 1517 |
| 3 | 76.4 | 75.5 | 485.17 | 30.09 | 36 | 71.6 | 70.5 | 1595 |
| 3 | 76.5 | 75.6 | 527.48 | 32.72 | 38.1 | 68.9 | 69.6 | 1490 |
| 4 | 75.4 | 74.5 | 321.25 | 19.93 | 46.4 | 68.3 | 73.5 | 1560 |
| 5 | 75 | 74.5 | 487.07 | 30.83 | 38.7 | 65 | 62.6 | 1065 |
| 6 | 77.7 | 77.3 | 497.07 | 30.83 | 35.4 | 60.9 | 62.9 | 1154 |

TABLE 7
Additional Processing Parameters Commercial Examples 1-6

| | | Calculated | | Flour | | | | |
|---|---|---|---|---|---|---|---|---|
| | Input | Dough | Flour | Feed | Mixer | Extruder | Screw | Mixer |
| | Moisture | Moisture | Temp | Rate | Vacuum | Amps | Speed | Speed |
| Example | (%) | (%) | (° C.) | (Kg/hr) | (IN/Hg) | (Amps) | (RPM) | (RPM) |
| 1 | 12.67 | 31.6 | 19.8 | 79.93 | −13.66 | 10.7 | 29.6 | 97.9 |
| 2 | 12.67 | 32.4 | 14.3 | 79.33 | −13.2 | 12.3 | 29.6 | 99 |
| 2 | 12.67 | 33.2 | 17.5 | 79.93 | −13 | 12.9 | 29.1 | 99 |
| 3 | 12.67 | 36.6 | 15.1 | 79.93 | −13.76 | 13.3 | 29.1 | 99.8 |
| 3 | 12.67 | 38 | 16.7 | 79.93 | −12.34 | 12.8 | 29.1 | 99.4 |
| 4 | 12.67 | 30.1 | 21.5 | 79.93 | −11.38 | 11.7 | 31.3 | 99.4 |
| 5 | 12.67 | 36.9 | 17.1 | 79.9 | −13.08 | 10.8 | 29.1 | 100.1 |
| 6 | 12.67 | 36.9 | 15.5 | 79.9 | −12.66 | 11.2 | 29.6 | 99.8 |

Ingredients for examples 1B-9B and 1-6: The following ingredients were used alone or in combination in Examples 1B-9B and Examples 1-6: Puris™ Chickpea flour: raw [35-39 dwt. % starch] & precooked [35-39 dwt. % starch]; Puris™ Pea flour: raw [38-42 dwt. % starch] & precooked [38-42 dwt. % starch]; Puris™ Pea starch: raw [84-88 dwt. % starch] & precooked [84-88 dwt. % starch]; and Puris™ Pea Fiber: raw [20-40 dwt. % starch]. The pea protein was Puris™ Pea 870 Protein and Puris™ Pea 870H Protein. All of these ingredients were commercially produced by PURIS (Minneapolis, Minn. USA).

Sensory Evaluation of Commercial Examples 1-6: A sensory panel was run with untrained panelists. The panel included a Comparison Sample (Organic Chickpea Fusilli) [Ingredients: Organic Chickpea Flour, Organic Brown Rice Flour, Organic Tapioca Starch, Organic Pea Protein] (Explore Cuisine, Red Bank, N.J.), and samples of Examples 1 through 6. Separate pots of water were placed on a stove and heated until all pots were rapidly boiling and between 99.5° C. and 99.9° C. Approximately two cups of pasta of each Example and the Comparison Sample were poured individually directly into the boiling water and boiled for seven minutes. Pastas were gently stirred once for three rotations around the edge of the pot. Pastas were strained immediately after seven minutes and placed in a labeled bowl. Approximately 1 tsp of sunflower oil was mixed into each sample to prevent clumping. Pastas were covered to retain as much heat as possible and to prevent surface drying while the remaining samples were prepared. All samples were at room temperature during the panel.

Instruction and overview of panel objectives were given to panelists prior to beginning the panel. Panelists were allowed to try samples as many times as desired. A sensory evaluation packet was provided and inquired about the taste, cohesiveness, elasticity, appearance, and overall liking of the examples compared to the comparison sample. The panel ended with a preference ranking of each of the Examples, including the Comparison Sample. Panelists were advised not to communicate with each other.

The taste, cohesiveness, elasticity, appearance, and overall liking were compared to the Comparison Sample. The Comparison Sample was chosen for its perception as being one of the top tasting and textured pulse based, gluten free pastas on the market. Sensory sheets consisted of modified hedonic scales from 1 to 5; with 1 being less of the characteristic (taste, cohesiveness, elasticity, etc.) compared to the Comparison Sample, 3 being the same as the Comparison Sample, and 5 being more of the characteristic than the Comparison Sample. The evaluation of taste appeared to confuse the panelists and should be disregarded for this sensory panel. Panelists wanted to score taste by their own personal preference instead doing a comparison to the Comparison Sample.

The definition of “how well a product binds when chewing” was provided for cohesiveness. Low cohesiveness would indicate that the product is disintegrating when chewed or is mushy when chewed, whereas high cohesiveness would indicate lower dissolving while chewing, or gumminess of the product. Examples 1, 2, 5 and 6 were very similar in cohesiveness to the Comparison Sample. Examples 3 and 4 were slightly less cohesive than the Comparison Sample and had no structure after mastication. Elasticity (also called springiness) was also evaluated in this sensory panel. The definition of “the springiness or ‘bite’ when chewing” was provided for the definition of elasticity. A low elasticity would indicate that the product has no body, whereas a high elasticity would resemble chewing on a rubber band. Examples 1, 2, and 6 had higher elasticity than the comparison sample, which indicated product improvement over Comparison Sample. Examples 3 and 4 were considered more elastic by some individuals and less elastic by other, which indicated a range of pasta texture preferences among the panelists. Also, this could indicate lack of understanding of the principle and results in inconclusive data. The appearance was also evaluated in this sensory panel. Example 5 had the most desirable appearance and Example 4, the least.

The overall preference of the Examples versus the Comparison Sample was evaluated in this panel. Example 1 had the highest preference compared to the Comparison Sample, whereas Example 4 had the lowest comparison to the Comparison Sample. The final preference ranking between all of the examples and the Comparison Sample supported this finding with the following order of preference: Example 1, Example 6, Example 2, Example 3, Comparison Sample, Example 5, and Example 4. This data indicated that in consideration of all characteristics evaluated by the panel (either explicitly or implicitly), Examples 1, 6, 2, and 3 were improvements over the Comparison Sample. Example 4 was clumpy and sticky, which were not preferred pasta characteristics. Example 5 had a higher beany flavor, which might have overruled preferred physical characteristics. For example, Examples 5 and 6 were similar in many physical properties, but beany flavor combined with physical properties could have collectively influenced panelists in their overall liking scoring.

In an effort to evaluate the gluten free pasta product of embodiments of the current disclosure, Examples 1-6 were evaluated in a sensory test with both a Comparative Sample (Bonza Rotini, Bonza, LLC., Detroit, Mich.) and a commercial wheat based pasta sample (Barilla Whole Grain Rotini, Barilla America Inc., Northbrook, Ill.). Table 8 gives the results of the sensory test.

TABLE 8
Sensory Test Examples 1-6 and Comparative. Sample

| Sample | Cohesiveness | | | | Springiness | | | | Hardness | | | |
|---|---|---|---|---|---|---|---|---|---|---|---|---|
| Wheat | 7.0 | 5.5 | 4 | 5.5 | 6 | 4 | 4 | 4.66 | 5 | 4 | 4 | 4.33 |
| Pasta | | | | | | | | | | | | |
| (Barilla) | | | | | | | | | | | | |
| CS* | 5 | 2 | 4.5 | 3.83 | 2 | 2 | 2 | 2 | 2 | 4 | 1 | 2.33 |
| (Banza) | | | | | | | | | | | | |
| 1 | 4 | 6 | 3 | 4.33 | 5 | 6 | 5 | 5.33 | 4 | 3 | 3 | 3.33 |
| 2 | 3 | 4 | 2.5 | 3.16 | 4 | 4 | 3 | 3.66 | 5 | 7 | 3 | 5.0 |
| 3 | 4 | 5 | 5 | 4.66 | 5 | 5 | 6 | 5.33 | 3 | 5 | 3 | 3.66 |
| 4 | 1 | 0 | 0 | .33 | 1 | 0 | 0 | .33 | 1 | 0 | .5 | .5 |
| 5 | 3 | 5 | 4 | 4.0 | 5 | 3 | 4 | 4 | 4 | 4 | 4 | 4 |
| 6 | 3 | 5 | 3.5 | 3.83 | 5 | 3 | 3.5 | 3.83 | 4 | 4 | 3 | 3.66 |

*CS = Comparitive Sample

Table 8 includes the results of a qualitative sensory test of n=3 (trained panelists). Sample amounts of each of Examples 1-6 and a Comparative Sample (Banza Rotini gluten free pasta) were cooked in boiling water and evaluated for cohesiveness, springiness (i.e., elasticity) and hardness (i.e., firmness of first bite). Samples were tested blind.

Results in Table 8 indicate that all but Example 4 were an improvement in sensory attributes over that of the Comparative Sample, as all were closer to the wheat pasta than the Comparative Sample.

Cohesion: As the wheat pasta sample was more cohesive than the Comparative Sample, Examples having higher cohesive scores would be improvements over the Comparative Sample. Examples 1, 3, & 5 were more cohesive than the Comparative Sample.

Springiness: As the wheat pasta sample was more springy than the Comparative Sample, Examples having higher springiness scores would be improvements over Comparative Sample. All Examples had higher springiness scores than the Comparative Sample.

Hardness: As the wheat pasta sample was more hard than the Comparative Sample, Examples having higher hardness scores would be improvements over the Comparative Sample. Examples 1, 2, 3, 5, and 6 had higher hardness scores than the Comparative Sample.

Water Uptake and Physical Compression Testing:

Pasta water uptake (that is the weight gained by pasta when dry pasta is cooked for 7 minutes in boiling water) is important to both consumers and manufacturers for two major reasons: water is an inexpensive ingredient and water uptake effects cooked pasta product texture.

Protein, starch, and fiber all have the capacity to absorb water under heated conditions. Because pasta was cooked from the dry state in boiling water, the protein, starch, and/or fiber typically must be able to absorb water while maintaining its physical structure. The physical structure was evaluated by sensory texture evaluation and by physical testing, such as compression under constant weight.

TABLE 9
Pasta Product Compression and Water Uptake.

| | | | | | | | | | Final | Increase | Water |
|---|---|---|---|---|---|---|---|---|---|---|---|
| | Initial | Final | | | | Initial | Final | Initial | Cooked | in wt. | absorbed |
| | Pasta | Pasta | | | Difference | Water | Water | Pasta | Pasta | after | per gram |
| | Height | Height | Height/wt | Compression | in Volume | wt. | wt. | wt. | wt. | cooking | of pasta |
| Example | (mL) | (mL) | (mL/g) | (%) | (cm^{\hat{ }}3) | (g) | (g) | (g) | (g) | (%) | (g) |
| Comparison | 300 - | 310 | 2.04, 1.67 | 18.14 | 76.32 | 700 | 295 | 100.81 | 185.88 | 84.38 | .84 |
| sample- | Uncooked | | | | | | | | | | |
| wheat | 380 - | | | | | | | | | | |
| | Cooked | | | | | | | | | | |
| 1 | 300 - | 280 | 2.09, 1.54 | 26.31 | 109.5 | 700 | 400 | 87.11 | 181.31 | 111.99 | 2.08 |
| | Uncooked | | | | | | | | | | |
| | 380 - | | | | | | | | | | |
| | Cooked | | | | | | | | | | |
| 2 | 300 - | 260 | 2.18, 1.58 | 27.52 | 109.5 | 700 | 410 | 86.44 | 164.88 | 90.74 | 1.91 |
| | Uncooked | | | | | | | | | | |
| | 360 - | | | | | | | | | | |
| | Cooked | | | | | | | | | | |
| 3 | 300 - | 200 | 1.91, 1.27 | 33.51 | 116.15 | 700 | N/A | 80.30 | 156.93 | 95.43 | 1.95 |
| | Uncooked | | | | | | | | | | |
| | 300 - | | | | | | | | | | |
| | Cooked | | | | | | | | | | |
| 4 | 300 - | 150 | 1.12, .989 | 11.69 | 23.23 | 700 | 380 | 81.93 | 151.52 | 84.94 | 1.84 |
| | Uncooked | | | | | | | | | | |
| | 170 - | | | | | | | | | | |
| | Cooked | | | | | | | | | | |
| 5 | 300 - | 220 | 2.00, 1.38 | 31.00 | 116.14 | 700 | 385 | 74.47 | 159.7 | 114.45 | 2.14 |
| | Uncooked | | | | | | | | | | |
| | 320 - | | | | | | | | | | |
| | Cooked | | | | | | | | | | |
| 6 | 300 - | 280 | 2.20, 1.62 | 26.36 | 109.5 | 700 | 365 | 75.31 | 173.04 | 129.77 | 2.29 |
| | Uncooked | | | | | | | | | | |
| | 380 - | | | | | | | | | | |
| | Cooked | | | | | | | | | | |

Table 9 includes Pasta Product compression and water uptake test data for Comparison Sample (Barilla Rotini) [Ingredients: Semolina (Wheat), Durum Wheat Flour] (Barilla America, Inc., Northbrook. Ill.) and samples of Examples 1-6.

Test objective: Compare pasta product Examples of embodiments of the current disclosure to see differences in the amount of compression observed when subjecting cooked pasta to a 500 g weight. Also, to evaluated differences in the amount of water absorbed by each example pasta during its cooking process.

Test Method:
1. Filled a pot with 700 g of water (3 cups) and began to heat the pan.
2. Filled a 1000 mL cylinder to approximately 300 mL with dry pasta.
3. Once water began to boil, poured weighed pasta in boiling water and cooked (Comparison Sample—10 minutes [box directions] and Examples—7 minutes [cooking time to achieve best texture]).
4. Drained excess water from the cooked pasta samples. Excess water used to measure the weight of pasta after cooking. The cooked pasta was weighed after cooking and draining.
5. Filled cooked pasta in a cylinder and using a 500 g weight with a disk attached (for even compression), measured the starting height and ending height of the pasta after 60 seconds of compression.

Table 10 includes Pasta Product compression and water uptake test data for Comparison Sample (Barilla Rotini) [Ingredients: Semolina (Wheat), Durum Wheat Flour] (Barilla America, Inc., Northbrook. Ill.) and samples of Examples 1-6. After Storage

Test objective: Compared pasta product samples (i.e., Comparison Sample Barilla Rotini {wheat} and Examples 1-6) to see differences in the amount of compression observed when subjecting to a weight after cooked pasta, that has been stored at refrigerated and frozen temperatures is reheated.

Test Method:
1. Filled a pot with 700 g of water (3 cups) and began to heat the pan.
2. Filled a 1000 mL cylinder to approximately 300 mL with dry pasta.
3. Once water began to boil, poured weighed pasta in boiling water and cooked (Comparison Sample—10 minutes [box directions] and Examples—7 minutes [cooking time to achieve best texture]).
4. Drained excess water from the pasta. Measured the excess water and used the weight to measure the pasta weight after cooking. Also, weighed the cooked pasta after cooking.
5. Filled cooked pasta in a cylinder and using a 500 g weight with a disk attached (for even compression), measured the starting height and ending height of the pasta after 60 seconds of compression.

TABLE 10
Pasta Refrigerated and Frozen Storage Compression and Water Uptake.

| | Initial Pasta | | Final Pasta | | | | | |
|---|---|---|---|---|---|---|---|---|
| | Height (mL) | | Height (mL) | | Height/wt (mL/g) | | Compression (%) | |
| Sample/Example # | Refrigerator | Freezer | R | F | R | F | R | F |
| Comparison | 300 - | 300 - | 380 | 360 | 4.23, 3.35 | 4.40, 3.23 | 20.8 | 26.59 |
| Sample- | Uncooked | Uncooked | | | | | | |
| Wheat | 480 - | 460 - | | | | | | |
| | Cooked | Cooked | | | | | | |
| Sample 1 | 300 - | 300 - | 370 | 360 | 4.93, 3.72 | 4.99, 3.74 | 24.54 | 25.02 |
| | Uncooked | Uncooked | | | | | | |
| | 490 - | 480 - | | | | | | |
| | Cooked | Cooked | | | | | | |
| Sample 2 | 300 - | 300 - | 340 | 380 | 5.35, 3.79 | 5.19, 4.11 | 29.15 | 20.80 |
| | Uncooked | Uncooked | | | | | | |
| | 480 - | 480 - | | | | | | |
| | Cooked | Cooked | | | | | | |
| Sample 3 | 300 - | 300 - | 310 | 300 | 5.44, 3.83 | 5.15, 3.77 | 29.59 | 26.79 |
| | Uncooked | Uncooked | | | | | | |
| | 440 - | 410 - | | | | | | |
| | Cooked | Cooked | | | | | | |
| Sample 4 | 300 - | N/A | N/A | N/A | N/A | N/A | N/A | N/A |
| | Uncooked | | | | | | | |
| | N/A - | | | | | | | |
| | Cooked | | | | | | | |
| Sample 5 | 300 - | 300 - | 330 | 320 | 6.22, 4.23 | 6.10, 4.24 | 31.99 | 30.49 |
| | Uncooked | Uncooked | | | | | | |
| | 470 - | 460 - | | | | | | |
| | Cooked | Cooked | | | | | | |
| Sample 6 | 300 - | 300 - | 360 | 360 | 6.49, 4.97 | 6.10, 4.58 | 23.42 | 24.91 |
| | Uncooked | Uncooked | | | | | | |
| | 470 - | 480 - | | | | | | |
| | Cooked | Cooked | | | | | | |

FIG. 10. Shows results of the pasta cook test including pasta height before and after compression by a 500 g in a Compression Test.

Cooked Pasta Stability with Refrigerated and Freezing Storage:

Cooked Examples 1-6 pasta product of embodiments of this disclosure maintained freshness (that is there were no flavor or texture changes) after five days when Examples were stored at refrigerated temperatures. The cooked pasta product samples were stored combined with tomato based commercial pasta sauce (in a 2:1 ration pasta to sauce) in airtight containers at approximately 35° F. The pasta product and sauce were then microwaved to reheat the pasta with sauce, and then evaluated for taste and texture. The pasta had maintained is texture, bite, and taste through storage and reheating.

Cooked Examples 1-6 pasta product of this disclosure were stored with tomato based commercial pasta sauce (in a 2:1 ration pasta to sauce) in air tight containers at freezing temperatures. The frozen pasta and sauce samples were then reheated via microwave oven and the evaluated for taste and texture. The pasta maintained texture, bite, and taste through storage and reheating.

The results in Tables 2 through 10 support the premises that the gluten free pasta product of the current disclosure had consumer and manufacturer desired improvements over that of products currently available commercially. Table 1 includes the results of sensory evaluations of several commercially available gluten free pastas.

The gluten free pasta product of embodiments of the current disclosure did not include any gums, but created and maintained the pastas' cohesion, springiness, and hardness (bite) through the use of particular combinations of pulse ingredients, including pulse ingredients made by, but not limited to, Puris (Minneapolis, Minn. USA) (i.e., PURIS™ pulse flours, proteins, starches, and fibers). The gluten free pasta of the present disclosure remained elastic and intact through cook up and maintained good texture even after reheating post storage in refrigerated and freezing temperatures. When compared to other gluten free pulse pastas on the market, the gluten free pasta product of the current disclosure displayed more elasticity and bite. The gluten free pasta product of embodiments of the present disclosure also had greater water clarity (i.e., lack of slough-off) during cook up when compared to competitors.

Multiple gluten free pasta product formulations were attempted prior to the present gluten free pasta product disclosure in kitchen and bench-top trials. Multiple variables resulted in undesirable characteristics in cooked pasta. For example, the type of pea protein in protein fortified products was useful for obtaining a pasta that maintained bite and did not leach pasta mass into cooking water. Some protein materials used for fortification of pasta resulted in a pasta that was difficult to extrude, pasted in mouth (i.e., not cohesive, got mushy), had no structure (i.e., not cohesive or springy or hard), leached into water (i.e., had slough-off), and had a strong beany off-flavor. The gluten free pasta product of embodiments of the present disclosure utilized a protein that aided the structure of the pasta, which improved the entire pasta process from extrusion, to cooking, and finally to tasting. Embodiments of the current disclosure utilized a protein that did not have an overwhelming flavor. The preferred protein was based on peas. Of the two pea protein products evaluated in the bench production Examples formulas, the Example with Pea Protein 870 created a firmer, less mushy gluten free pasta product than the Example with Pea Protein 870H. Both of these protein products were commercial products of Puris (Minneapolis, Minn. USA). Pea Protein 870H was a partially hydrolyzed version (and so, contained some smaller protein molecule lengths) of Pea Protein 870.

An optional protein to use in making pasta would include pea peptides, pea solubles, and pea albumin, as these pea protein sources are soluble in water. When combined with other materials in a pasta dough, these proteins could add body and structure to the pasta. The structure would be such that the pasta could handle high temperatures and pressures, such as that of products being retorted or canned or boiled for extended time in excess water. The structure would also be such that it could handle several rounds of heating and reheating, as well as several rounds of freezing ad thawing.

The type of pulse flour utilized in pasta product embodiments of the current disclosure was useful for creating the excellent gluten free pasta product that maintained structure through extrusion and cooking. Trial and error determined that too much of a certain pulse flour (for example, chickpea) resulted in a pasta with an overwhelming beany flavor, a pasta that cracked during extrusion, and a pasta that lost form and mass when cooked. The resulting pasta with chickpea flour had minimal bite and pasted immediately upon mastication (i.e., mushy, low cohesive, soft).

The amount and type of starch in the formulation of the gluten free pasta product of embodiments of the current disclosure was an important aspect to the present disclosure. A series of experiments indicates that too high amounts of pulse starch resulted in a pasta with poorer structure and that pasta was softer and less cohesive when cooked. Further testing indicates that use of process steam and decreased pasta maker pump flow rate should have allowed the pulse starch to gelatinize more, but that had failed to produce a pasta with desirable texture after cook up (See Example 4). This pasta appeared to be firm upon extrusion, but had no body and clumped when cooked. Alternatively, embodiments of the current disclosure reflect that adding no pulse starch (other than that in the flour) into the formula resulted in a firmer cooked pasta with shorter texture. The ranges of pulse starch in the formulations of the gluten free pasta product embodiments of the current disclosure are the preferred amounts of total starch in the gluten free pasta product.

Certain examples of gluten free pasta of the current disclosure include PURIS™ Pre-Gel Pea Starch (i.e., Pea Starch—precooked). This starch was utilized along with or instead of PURIS™ Pea Starch (i.e., Pea Starch—Raw). The gluten free pasta embodiments of the current disclosure can use the addition of PURIS™ Pre-Gel Pea Starch to enhance the bite (i.e., firmer) of the pasta as well as created a stronger structure. This stronger structure allowed the gluten free pasta to maintain shape and texture through cook up, which resulted in better chewing texture (i.e., bite, elasticity, and cohesion) and physical strength (i.e., texture and less slough-off).

The gluten free pasta product of embodiments of the current disclosure are not limited by the color of the resulting dried or cooked pasta. The examples of gluten free pasta product of embodiments of the current disclosure had varied color, according to the type of pulse flour and amount of starch utilized. Pasta examples that utilized darker pulses, such as chickpeas, created a pasta that was darker in color and resembled the color of whole wheat pasta. Pasta examples that utilized greater amounts of starch lightened the pasta color and counterbalanced the darkness of the dark pulses. The pasta examples that utilized lighter colored pulses, such as yellow field peas versus chickpeas, resulted in a very light colored pasta, which resembled a standard semolina wheat pasta. Speckled coloring occurred with some of the pulse pasta examples due to pulse hulls included in the flour or added as fiber.

Pasta-Like Products

Traditional pasta-like products may be described as, but not limited to, crunchy expanded snacks, inclusions, and RTE breakfast cereals; flexible texturized protein, meat analogs, dairy analogs and confections; and flexible films and molded pieces. These products traditionally contain plant based materials (e.g., wheat flour, or soybean flour) and also allergen proteins (e.g., milk proteins, egg proteins, soy proteins), which are processed with heat and shear, for example with extruder equipment. There is a market need to develop and manufacture pasta-like products with consumer expected textures and flavors while replacing allergenic proteins with non-allergenic ingredients without use of emulsifiers, modified starches, and other ingredients that consumers also do not want in the products they purchase.

Though traditional pasta-like products may contain plant based materials, the use of pulse plant materials can create added benefits while still providing the flavor and texture attributes expected by consumers for products of this type. In embodiments of this disclosure, pulse materials impart the flavor and texture desired, without use of allergens, gluten, or chemical ingredients (such as emulsifiers and modified starch). As already discussed for pasta product embodiments of the current disclosure, embodiments of the current disclosure discuss utilization of pulse materials (e.g., starch, fiber, protein, and flour) to create and control expansion, control contraction, and create either hardness or flexibility as needed to create healthy pasta-like products for the consumer.

Embodiments of this disclosure include pasta-like products that are brittle and crunchy, as well as pasta-like products that are chewy or flexible. The benefit of pulses could be due to pulses (especially peas and chickpeas) containing unique ingredients (such as starch with high levels of amylose) that have unique functional properties (such as, but not limited to, gelling properties).

Crunchy Texture Pasta-Like Products

Consumers desire snacking products that are crunchy in texture. Examples of such products include but are not limited to RTE breakfast cereal, crackers, wheat chips, and puffed snacks. The commonality of these products is brittle texture, a crunchy texture (e.g., both tactile and audio sensory), and an aerated appearance. Another commonality of these products is that they are usually made with wheat flour, which contains gluten. There have been attempts by manufacturers to substitute wheat flour with soybean flour or with grain flours, though often with the addition of egg whites or milk proteins to shore-up the lack of gluten protein functionality. The resulting products, besides containing allergens, often have undesirable flavors that need to be masked by seasonings or flavors. The pasta-like products of embodiments of the current disclosure are able to deliver the consumer desired crunchy texture without undesired allergen ingredient content or undesired “cardboard” or “beany” flavor from soybeans and grain flours. The pasta-like products of embodiments of the current disclosure also meet “clean label” requirements of no gums, chemical emulsifiers, or modified starches.

TABLE 11
Bench Formulation Examples: Crunchy Texture Pasta-Like Products

| Ingredients (as is wt. | | | | |
|---|---|---|---|---|
| %) | A | B | C | D |
| Pulse Flour | 66-88 | 76-96 | 0-5 | 0-5 |
| Protein Isolate | 0-3 | 0-3 | 68-85 | 74-89 |
| Pulse Fiber | 0 | 0 | 0 | 0 |
| Pulse Starch | 0 | 0 | 0-5 | 0-5 |
| Rice Starch/Waxy | 17-22 | 0-9 | 17-25 | 0 |
| Rice Starch | | | | |
| Tapioca Starch | 4-8 | 0-14 | 0-5 | 17-23 |
| Calcium Carbonate | 0.2-1.2 | 0.2-1.2 | 0.2-1.2 | 0.0-1.2 |
| Flavoring materials, | 0-2 | 0-2 | 1-4 | 0-3 |
| color materials | | | | |

Table 11 includes the formulas for several Examples of hard and crunchy textured pasta-like products that are embodiments of this disclosure. Example batches were made of Examples A-D using pea materials from PURIS (Minneapolis, Minn.). Both pea flour (PURIS™ Pea Flour, PURIS, Minneapolis, Minn.) and chickpea flour (PURIS™ CCP) were used in Example batches of Example A and Example B. The pulse protein isolate (PURIS™ P870H), pulse starch (PURIS™ PS85) and pulse fiber (PURIS™ CYP-RF) used in Examples A-D were commercial pea materials supplied by PURIS (Minneapolis, Minn.).

Examples A and B were slightly harder and slightly less brittle when made with pea flour than when Examples A and B were made with chickpea flour. Examples C and D were made with pea flour, and were found to be harder than Examples A and B made with pea flour and when made with chickpea flour. The cause of the greater hardness was because the formulas for Examples C and D were much higher in protein than the formulas for Examples A and B. Batches of Examples A and B had proximate analysis protein contents of 17% and 20% respectively. Batches of Examples C and D had proximate analysis protein contents of 55% and 60% respectively. This would mean that Examples A and B had higher carbohydrate contents then Examples C and D.

The Examples in Table 11 were produced using an extruder, wherein the extruder was heated at least to 150-300 F and had a die at its exit port. The ingredients were mixed into a dough in the extruder, heated in the extruder, passed through a port exit die, expanded in diameter as it left the die. Finally the expanded dough was cut into pieces after exiting the die. The expanded dough pieces were then optionally dried in an oven so that the final product moisture content was less than 7%. The expanded dough pieces were optionally coated with spices or other flavoring ingredients along with oil and/or water. Expanded pasta-like dough pieces of Examples A-D in Table 11 were crunchy in texture before and after coating application.

As previously discussed, many factors affect the expansion of a dough as it leaves an extruder. The Examples in Table 11 were made with ingredients and under formula and processing conditions that encouraged and developed an expansion of the dough as it left the extruder.

The combinations of protein, starch, and fiber (in isolated forms, semi-isolated forms, pulse flour, or combinations thereof) act together to create extruded pieces that have an expanded structure. These expanded piece structures are able to maintain at least some of their expanded structure upon cooling to ambient temperature and ambient pressure.

Examples A and B had lower protein content and higher starch content then Examples C and D. Examples C and D were harder in texture than Examples A and B. The differences can be at least partially explained by their compositions. Not to be limited by any theory, there were two matrixes formed in these Examples: one carbohydrate based and another protein based. The carbohydrate molecules (e.g., amylose starch, amylopectin starch, and fiber) were at least partially melted and/or gelatinized in the heat and shear of the extruder. When they cooled outside of the extruder, they bonded with each other, retrograded and hardened. This is supported by results when pea starch was extruded alone. The pea starch created an expanded, glassy, and hard textured matrix. The protein molecules in the Examples were at least partially unraveled and elongated in the heat and shear of the extruder. When they cooled outside of the extruder, they created bonds between protein strands that created a three dimensional matrix. The starch and proteins matrixes would have at least partially inhibited each other's self-bonding. With Examples A and B, it appeared that the less hard protein matrix dominated. With Examples C and D, it appeared that the more hard carbohydrate matrix dominated.

The higher the starch content, the harder the extruded pasta-like product texture. As already discussed, starch at least partially gelatinizes under the heat and shear conditions within an extruder, and the starch molecules would elongate and align with each other during the extruder mixing as well as during their passage through the extruder's exit port and die. Depending on heating and shear conditions in the extruder, a pulse starch could have melted, which means that the temperature of the starch was above the starches' Tg (glass transition temperature), putting starch into a fluid, melted physical state. Being fluid, this starch molecular structure would expand when the dough mass exited the extruder. Upon leaving the pressurized extruder, the water content of the dough would have expanded as it vaporized. As the water escaped and the dough mass cooled, the aligned starch molecules retrograded, that is, they contracted among themselves in an effort to reduce the energy of the molecules and to move towards crystallization. When the temperature of the dough mass dropped below the starch Tg, the melted starch would harden.

As already discussed, the protein within the dough was also active in and after the extruder. Under the heat and the shear of the extruder, as well the shear caused by through the extruder's exit port die, the protein molecules unraveled, elongated, and aligned with each other attempting to create a matrix in the dough. When the hot, stressed dough exited the extruder exit port die, the water content expanded and the dough mass also expanded. As the dough then cooled, the protein molecules attempted to bond with each other. When there is both starch molecules and protein molecules within a hot, stressed dough, they will interfere with each other's structure formation, especially as the dough cools. When there is more starch (and less protein) in the pasta-like products, the cooled expanded products will be harder than if there is less starch (and more protein). The crystallized starch structure is hard in nature. The protein structure also has a hardness, but the nature of the protein molecules lends itself to less crystallization and resulting hardness.

Expanded molecule flexibility would aid in expansion, but also aid in the contraction of the expanded dough mass as it cools. Starch that has at least partly gelatinized and melted would harden as the dough mass cools post-extruder. The hardening would allow the hot, stressed dough to remain in an open, aerated structure. The hardening of the starch, as well as some hardening of the protein, while maintaining an open, aerated structure would create a hard, brittle, crunchy finished pasta-like product texture.

The pasta-like products of Examples A-D also had some optional calcium carbonate in their dough formulas. The calcium carbonate created CO₂ under the mixing and heat conditions within the extruder. The CO₂ gas was under pressure until it followed the dough out of the extruder, when the gas then expanded. As already discussed with water vapor, the expansion of the gas aided in the expansion of the hot, stressed dough post extruder.

The role of pulse fiber ingredient in pasta-like product embodiments of the current disclosure is similar to that already discussed with pasta product embodiments of the current disclosure. Fiber has a saccharide backbone and as such would react to heat and stress similar to starch, though fiber has no starch granular structure to cook out during the extruder's heating and mixing processes. Fiber's structure does lend it to having some hygroscopic properties; trapping water during heating and mixing, and holding on to some of that water after exiting the extruder. Fiber's primary role is most likely to interfere with starch retrogradation and protein alignment and contraction.

The extruded expanded pasta-like product embodiments of this disclosure work well as gluten free alternatives to ready-to-eat (RTE) breakfast foods, as well as gluten free alternatives to crunchy snack alternatives, such as crackers and puffs. The extruded expanded pasta-like product embodiments of this disclosure are also excellent ingredients for use in composite foods, such as but not limited to granola, breakfast bars, bakery (as inclusions, particulates, crust ingredients, toppings), and dairy products (as inclusions, particulates, and toppings), Their gluten free contents make these extruded expanded pasta-like products excellent alternatives to nut pieces in various food products due to their potentially hard texture and toasted grain flavor.

Chewy Texture Savory Pasta-Like Products

Consumers desire snacks and entrée components that are chewy and flexible in texture, such as meat, dairy, and egg products. The commonality of these products includes high protein content, chewy and flexible texture, and sometimes an aerated appearance. Another commonality of these products is that they are traditionally made with animal sourced proteins (e.g., meat, egg, milk, and gelatin), with or without proteins from other sources (e.g., soybean and wheat flour). There have been attempts by manufacturers to create substitutes (i.e., pasta-like products) for these meat, dairy, and egg products by using soybean based ingredients, with and without use of animal sourced ingredients, and the heat and stress of extrusion processing. These alternative pasta-like products, contain allergens, and often have undesirable flavors and textures. The pasta-like products of embodiments of the current disclosure are able to deliver the consumer desired high protein content, as well as a chewy and flexible texture, without undesired allergen ingredient content or undesired flavors.

TABLE 12
Bench Formulation Examples: Chewy Texture Savory
Pasta-Like Products

| Ingredients (as is wt. | | | |
|---|---|---|---|
| %) | H | I | J |
| Pulse Flour | 0 | 0-40 | 0-40 |
| Protein Isolate | 92-100 | 60-100 | 60-100 |
| Pea Starch | 0 | 0 | 0-40 |
| Flavoring materials, | 0-8 | 0-8 | 0-8 |
| color materials | | | |
| Protein Content | 80% | 75% | 65% |

The Example formulas H, I, and J in Table 12 were pasta-like product embodiments of the current disclosure that lend themselves to high protein content, chewy and flexible texture, and savory flavored end product uses. Savory means non-sweet, such as meat, cheese, and egg flavors. The Example H formula in Table 12 contained about 92-100 dwt. % pea protein isolate. The Example I formula in Table 12 contained about 60-100 dwt. % pea protein isolate and about 0-40 dwt. % pea flour. The Example J formula in Table 12 contained about 60-100 dwt. % pea protein isolate and about 0-40 dwt. % pea starch. The formula contents of Examples H, I, and J were adjusted, that is the quantity of pea protein isolate, pea flour, pea starch were adjusted so that the combined percent pea protein was 80% for Example H; 70% for I; and 65% for J. All of these products had finished moisture of less than 9%. For easier process flow through an extruder, these formulas might have had more or less pea flour or pea starch added, though not at the expense of final pasta-like product protein content.

The Examples H, I, and J in Table 12 were produced using an extruder, wherein the extruder was heated at 250-300 F and had a die at its exit port. A rotating knife attached to the extruder on the exterior side of the die cut the pasta-like product dough as it exited the die. The ingredients were mixed into a dough, heated in the extruder, and then the hot, stressed dough passed through a die at the extruder exit port, with and without expansion as the hot, stressed dough exited the extruder. The extruded mass was in the form of a rope, which was cut into pieces as the rope exited the die. These dough pieces were, optionally, heated in an oven to reduce product moisture content. The pasta-like dough pieces were chewy and flexible in texture before being dried, and were chewy and flexible in texture after the dried form was rehydrated.

These chewy and flexible pasta-like products of embodiments of the current disclosure could be labeled as texturized protein, meat, dairy, or egg analog due to their high protein content and finished product texture. Flavors, colors, acids, salts, and combinations thereof could be added to the formulas to make the finished extruded pasta-like product embodiments of the current disclosures even more meat-, dairy-, and egg-like. The Examples H, I, and J were made with PURIS™ pea protein isolates, pea flour (optionally), and pea starch (optionally), though embodiments of the current disclosure are not limited to the source or brand of pulse ingredients.

As already discussed, pulse ingredients (that is protein, starch, and fiber in isolated form or in flour) were useful in creating extruded pasta-like products due to the ability of the protein and carbohydrate components to unravel, align, and stretch under presence of water, shear, and heat in and after an extruder. Pulse protein isolate at greater than 50% protein content and between pH 6 and pH 8 used in making the chewy and flexible pasta-like product embodiments of the current disclosure can be used to make meat analog patties and sausages, as well as diary analogs, such as but not limited to cheese pieces, cottage cheese, and cream cheese. Pulse protein isolate at greater than 50% protein content and between pH 6 and pH 8 can also be used to make pasta-like product embodiments of the current disclosure that are friable when in a dried form, which then comprise unique and useful hydration properties. Product formulators could take advantage of this friable nature. The pasta-like product could be ground and then be hydrated in particulate form to create dairy analog products, such as gluten free cottage cheese-like, gluten free ricotta-type cheese, and cheddar-like curd products. The friable pasta-like product embodiments could also be used as a high protein content, oatmeal-like breakfast food or as an gluten free scrambled egg alternative. Of course, the chewy pasta-like product could be added to meat and dairy containing products with the purpose of increasing protein content or altering finished product texture.

Chewy Texture Sweet Pasta-Like Products

Consumers desire chewy snacks that are sweet. Chewy confections that contain protein (e.g., gelatin, gluten, egg whites) and carbohydrates are usually made with excess water to dissolve the carbohydrates (especially sweeteners) and protein ingredients, and then the water is removed (such as through boiling and/or starch molds). Traditionally excess water is also needed in confection production to make a sweet dough mass less viscous, which is a necessity for depositing and molding processes. Sweet, chewy pasta-like products of embodiments of the current disclosure can comprise pulse protein and carbohydrates that can be converted into sweet tasting chewy pasta-like products using an extruder without the need for the excess water used in traditional production of chewy confections. The commonality of these traditional sweet products is a high protein content, a chewy texture, and sometimes an aerated appearance. In some cases, making sweet chewy pasta-like products in an extruder is very efficient as the shear of the dough in the extruder can be utilized to initiate and control crystal growth in the dough. Also, the mechanical action, with its inherent moving parts and shear, can move very viscous sweet dough through the mixing and cooking process without excess water. This also true for the sweet chewy pasta-like products of embodiments of the current disclosure that are more bakery (e.g., cookie) in character than confection (e.g., taffy).

TABLE 13
Bench Formulation Examples: Chewy Texture
Sweet Pasta-Like Products

| Ingredients | (as K wt. % | L wt. %) |
|---|---|---|
| Pulse Flour | 10-50 | 10-50 |
| Protein Isolate | 0-30 | 0-30 |
| Pea Fiber | 0-10 | 0-10 |
| Pea Starch | 10-50 | 5-30 |
| Rice Starch/Waxy Rice Starch | 0-22 | 0-22 |
| Tapioca Starch | 0-8 | 0-8 |
| Fat, Lipid, Emulsifier | 0-15 | 0-15 |
| Flavoring Materials, Colors | 0-8 | 0-8 |
| Sweeteners | 1-35 | 25-90 |

The Example K formula in Table 13 is an embodiment of the current disclosure that would be a cookie that would contain 5-40 dwt. % protein, 60-94 dwt % carbohydrate, 1-8 dwt. % flavors, colors, acids, high intensity sweeteners or combinations thereof. The carbohydrate composition could be 25-60 dwt. % starch and 75-40 dwt. % sweetener (including but not limited to polyols, sugars, maltodextrins, syrups, and combinations thereof). The resulting cookie product could be extruded in partially or fully cooked form.

The Example L formula in Table 13 is an embodiment of the current disclosure that would be a confection that would contain 5-40 dwt. % protein, 60-94 dwt % carbohydrate, 1-8 dwt. % flavors, colors, acids, high intensity sweeteners or combinations thereof. The carbohydrate composition could be 1-50 dwt. % starch and 30-80 dwt. % sweetener (including but not limited to polyols, sugars, maltodextrins, syrups, and combinations thereof). The resulting confection product could be downstream processed into individual pieces, or deposited into shaping molds.

The Example K and L formulas in Table 13 would be produced using an extruder, wherein the extruder would be heated high enough to heat the ingredients so as to melt the sweeteners, hydrate and unravel at least some of the proteins, and hydrate at least most of the starch. After thorough heating and mixing, the dough would be pushed out of the extruder through the exit port die. A rotating knife attached to the extruder on the exterior side of the die would cut the pasta-like product dough as it exited the die or the extruded dough could be deposited into shaping molds. The ingredients would be mixed into a dough and heated in the extruder, then the dough would be passed through the die with or without expansion in diameter as it left the die, and the extruded dough would be cut into pieces after exiting the die or could be poured or forced into shaping molds. The expanded (or unexpanded) dough pieces could then optionally be further dried in an oven. The extruded dough pieces could then optionally be coated with toppings, including spices, sweeteners, flavors and/or oil. Extruded pasta-like dough pieces would be soft and chewy in texture before and after coating application. Changes in formula (especially water content) and process conditions could be done so that to make the final extruded sweet product hard and/or crunchy. A differential in pressure between inside the extruder and after the extruder exit port could create an expanded product that is firm or hard, and thus crunchy. This would be especially true for dough with very high sugar content.

Ingredients used in the sweet pasta-like product embodiments of the current disclosure could be adjusted in terms of sweeteners versus starch and/or protein and/or flour to make a sweeter or less sweet tasting finished product and still be within the embodiments of this disclosure.

Flexible “Plastic” Films and Molded Pasta-Like Products

Another category of pasta-like product is flexible (also called “plastic”) product, also called “bioplastics”, can be made with carbohydrates (including isolated starch, isolated fiber, flour, and combinations thereof) and optionally with proteins. Because of the long polymer structure of many carbohydrates, such carbohydrates can be processed in such a way as to produce gels and/or films that can be made into sheets, ropes, or molded pieces. Utilizing carbohydrates to make flexible products allows for products that are made with renewable resources and/or are biodegradable, unlike petroleum based flexible products. Utilizing pulse carbohydrates can provide excellent gel and film formation properties of the amylose molecules of pulses.

TABLE 14
Formulation Examples: Flexible “Plastic” Films and
Molded Pasta-Like Products

| Ingredients (as is | |
|---|---|
| wt. %) | M |
| Pulse Flour | 0-40 |
| Protein Isolate | 0-30 |
| Pea Fiber | 0-20 |
| Pea Starch | 0-95 |
| Rice | 0-3 |
| Starch/Waxy | 0-3 |
| Rice Starch/ | |
| Tapioca Starch | |
| Calcium | 0-1 |
| Carbonate | |
| Flavoring | 0-5 |
| materials, color | |
| materials | |
| Hydrocolloid/ | 0-30 |
| Emulsifiers | |

The Example M formula in Table 14 could be used to produce flexible pasta-like products using an extruder, wherein the extruder would be heated high enough to heat the ingredients (i.e., dough) in the extruder so as to melt, hydrate, and unravel at least some of the protein molecules (when present); as well as melt, hydrate, and unravel at least some of the starch molecules, and possibly some of the molecules (when present). After thorough heating and mixing, the dough would be pushed out of the extruder through the exit port and die. The shear of the mixing within the extruder and the shear applied to the dough as it is forced through the die will cause at least some alignment of the unraveled protein molecules (when present), the starch molecules, and the fiber molecules (when present) within the extruded dough. For film pasta-like products of embodiments of the current disclosure, the extruder exit port die would be a slit (i.e., opening) of the desired width (or multiples of width) of the desired finished film product. The film could be cut into pieces by a rotating knife attached to the extruder on the exterior side of the die, or by a wire cutter, laser cutter, or other cutting means present upstream (that is, after) of the extruder. The differential in pressure between the inside of the extruder before the exit port die and the outside of the exit port die could be adjusted depending on the desired end structure and texture of the finished flexible film. As already discussed for pasta and other pasta-like product embodiments of the current disclosure, the differential in pressure will affect the density of the extruded film. The greater the differential in pressure, the greater the expansion of the molecules of the heated dough upon leaving the extruder. As the acts of forcing the dough through the extruder die and of forcing the dough to expand would aid in the arrangement of the molecules in the extruded dough, which could aid the finish product in being flexible post extruder.

With flexible pasta-like product embodiments of the current disclosure, the ingredients would be mixed into a dough and heated in an extruder, then the heated and shear stressed dough would passed through the extruder exit port die, and finally cut immediately after leaving the die. Or the extruded dough could fall onto a conveyor for transport to the cutting means. Optionally, the extruded film could be placed on or around a mass before or after it is cut into pieces. The extruded film pasta-like product could also be treated post extruder such as, but not limited to, dried in an oven or chilled in a cooler. The extruded film pieces could be coated with liquids or dry materials that would aid in the development of the extruded film pasta-like product's final amount of flexibility. Film pasta-like product pieces could be soft and flexible in texture until further processes (such as, but not limited to, heat application) are applied.

That which has been described for film pasta-like products would also be true of flexible, “plastic”, molded pasta-like product embodiments of the current disclosure. For flexible or “plastic” molded products would be molded into pieces after it leaves the extruder. The molding of the extruded flexible pasta-like product would be accomplished through injection molding, press (e.g., stamp) molding, or other means of molding known in the art. The molded pieces could then be further treated post extruder such as, but not limited to, drying in an oven or chilling in a cooler. The molded pieces could be coated with liquids or dry materials that would aid in the development of its final product's flexibility. The molded pieces could be subjected to additional processes after molding including, but not limited to, coating with liquids or dry materials and/or heating.

Flexible films and molded pasta-like product embodiments of the current disclosure are possible because of the long polymer molecules in carbohydrates, in particular starch (most particularly, amylose) and fiber (when present) as well as in proteins (when present). Because of the long polymer structure of many carbohydrates, such carbohydrates can be processed in such a way as to produce gels and/or films that can be made into sheets, ropes, or molded pieces. Using pulse based starch, especially pea or chickpea starch, in comparison with certain other starches, allows flexible film and molded pasta-like product embodiments because of the higher level of amylose starch in these pulses. The long, non-branched polysaccharide molecules of amylose allow pea and chickpea starch (preferably pea starch) to have excellent gelation, and so filming, functionality. To create gels, the amylose molecules unravel and yet bond with other amylose molecules so as to create a matrix. When that that matrix is flexible and contains moisture or other fluids (trapped within its matrix structure), the matrix is called a gel. A flexible film can be formed from a material that will create a gel under appropriate processing conditions to create a two dimensional product piece (i.e., film). When a flexible or “plastic” molded piece is desired, a gelling material of embodiments of the current disclosure could be poured (or forced) into a mold and that material would adhere to itself to form a semi-solid to solid product piece in a shape to match the mold. Certain embodiments of the current disclosure utilize the properties of high amylose starch in pulse starches to create films and molded pasta-like product embodiments with flexible or “plastic” texture when doughs containing the pulse starch is submitted to the heat and shear of an extruder. Not to be limited to any theory, but it seems that the unraveling and then alignment of the amylose polysaccharide molecules encourages bonding between amylose molecules, which under proper processing conditions create the matrix that can be used to create flexible or crunchy products.

The flexible and molded pasta-like product embodiments of the current disclosure can be excellent materials to use because of the pulse starch stability against degradation by acids and heat, especially compared to other plant starches such as corn, tapioca, and rice. These acid and thermal properties aid in forming extruded products that would be useful as films (such as for package wrapping) or molded products (such as packages or tableware).

In flexible and molded pasta-like products of embodiments of the current disclosure additional ingredients could be added that would affect the flexibility of the film and molded products. Such additional ingredients would include, but would not be limited to, fiber, protein, fats and/or oils, emulsifiers, coloring agents, flavoring ingredients, sweeteners, acids, salts, and combinations thereof. Of course, in scope of the current disclosure would be the addition of non-pulse ingredients. This includes the addition of non-pulse polymers. The advantage of addition of non-pulse polymers is that the polymers could unravel and intermix with the pulse starch (and protein and fiber when present), creating a polymer matrix within and throughout the starch matrix in the final extruded product. Theoretically because the polymer matrix would be more flexible than pure pulse starch matrix in part because the polymer molecules would interfere with some of the pulse amylose bonding with itself and retrograding (i.e., starch-starch bonds tightening, usually expelling fluids trapped between the starch molecules. Also the polymer matrix could be fluid at room temperature, where in the heated and shear stressed pulse starch matrix might not be flexible at room temperature due to retrogradation and/or moisture loss.

The addition of fiber, as already described for other extruded pasta-like product embodiments of the current disclosure, could create its own matrix throughout the pulse starch film or molded piece structure. Acting as a humectant, the added fiber could absorb water which would affect the full film product's texture as well give a humidity stability to the film or molded piece. Polyols, such as sorbitol and glycerol, would aid in creating flexible films and molded pasta-like product embodiments of the current disclosure due to their ability to interfere with some starch matrix formation and retrogradation, as well as absorb fluid water within the product structure. Polys would also act as humectants that would give humidity stability to flexible film and molded pasta-like products. Fats and oils would lubricate a dough as well as interfere with some starch matrix formation and retrogradation. Polyols, fats, and oils added to flexible films and molded “plastic” product pieces would also create some flexibility due to their fluid nature at room temperature, which would be a medium for the matrix components to move (e.g., flex, bend) within.

The dough content (i.e., starch with protein, fiber, polyol, fat, oil, other ingredients, or combinations thereof) could be adjusted so as to reach the desired film or molded pasta-like product flexibility. The starch, protein, and fiber could be in isolated form, flour, or combinations thereof. The extruder heat and shear conditions could be adjusted so as to reach the desired heat and shear conditions that would create the desired extruded film or molded pasta-like product flexible or “plastic” texture.

Utilizing plant starch, proteins, and fiber, such as that from peas and chickpeas, allows the resulting flexible films and molded pasta-like product embodiments of the current disclosure would be biodegradable, unlike petroleum based flexible films and molded “plastic” products currently available commercially. Consumers are conscious of the damage to environment that occurs when petroleum based plastics are used in disposable film, packaging containers, and tableware.

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

The compositions, articles, apparatuses, and methods of the present disclosure are capable of being incorporated in the form of a variety of embodiments, only a few of which have been illustrated and described. The disclosure may be embodied in other forms without departing from its spirit or essential characteristics. The described embodiments are to be considered in all respects only as illustrative and not restrictive, and the scope of the disclosure, therefore, is indicated by the appended claims rather than by the foregoing description. All changes which come within the meaning and range of equivalency of the claims are to be embraced within their scope.

We claim:

1. A food product comprising:
a) about 0-40 dwt. % pulse flour;
b) about 60-100 dwt. % pulse protein isolate or concentrate;
c) about 0-8 dwt. % additives; and
d) about 0-50 dwt. % pulse protein ingredient selected from a group comprising pulse protein peptides, pulse protein albumin, soluble pulse protein, and combinations thereof; wherein the food product consists of essentially no gluten.

2. The food product of claim 1, wherein the additives are selected from a group comprising flavor agents, color agents, aeration agents, minerals, salts, acids, bases, bulk sweeteners, high intensity sweeteners, and combinations thereof.

3. The food product of claim 1, further comprising a pulse protein content of about 50-95 dwt. % and the food product does not contain an ingredient that is any type of wheat, rye, barley, or crossbreeds of these grains, the product does not contain an ingredient derived from these grains that has not been processed to remove gluten, or the product does not contain an ingredient derived from these grains that has been processed to remove gluten, but results in the food containing more than 20 ppm of gluten.

4. A pasta-like product comprising:
a) about 0-96 dwt. % pulse flour;
b) about 100-0 dwt. % pulse protein isolate or concentrate;
c) about 0-95 dwt. % starch;
d) about 0-15 dwt. % additives; and
e) about 0-50 dwt. % pulse protein ingredient selected from a group comprising pulse protein peptides, pulse protein albumin, soluble pulse protein, and combinations thereof; wherein the pasta-like product comprises of less than 35 ppm of gluten.

5. The pasta-like product of claim 4, wherein the additives are selected from a group comprising flavor agents, color agents, aeration agents, minerals, salts, acids, bases, bulk sweeteners, high intensity sweeteners, and combinations thereof.

6. The pasta-like product of claim 5, further comprising a total pulse protein content of about 15-70 dwt. % protein.

7. The pasta-like product of claim 5, further comprising a total pulse protein content of about 5-40 dwt. %, and a carbohydrate content of about 60-95 dwt. %; wherein the total carbohydrate content comprises about 25-60 dwt. % starch and about 75-40 dwt. % bulk sweetener.

8. The pasta-like product of claim 5, further comprising a total pulse protein content of about 5-40 dwt. %, and a total carbohydrate content of about 60-90 dwt. %, wherein the total carbohydrate content comprises about 1-10 dwt. % starch and about 99-90 dwt. % bulk sweetener

9. A food product comprising the pasta-like product of claim 4, wherein the food product comprises at least a partially expanded appearance, and has a chewy, flexible, hard, or crunchy texture.

10. The food product of claim 9, wherein the food product is selected from a group comprising meat analog, dairy analog, egg analog, chewy confection, and combinations thereof.

11. A food product comprising the pasta-like product of claim 4, wherein the food product is selected from a group comprising breakfast cereals, snacks, inclusions, puffs and combinations thereof, wherein the food product is hard and crunchy in texture.

12. The pasta-like product of claim 4, wherein the additive is selected from a group comprising flavor agents, color agents, aeration agents, minerals, salts, acids, bases, bulk sweeteners, high intensity sweeteners, humectants, non-pulse based starches, non-pulse based proteins, non-pulse based fiber, hydrocolloids, oils, fats, glycerol, and combinations thereof.

13. A food product comprising the pasta-like product of claim 12, wherein the food product is flexible and can be molded before drying and after hydration.

14. A pasta product comprising:
a) about 50-95 dwt. % pulse carbohydrate;
b) about 8-50 dwt. % pulse protein; and
c) less than about 6 dwt. % pulse fat; wherein the pasta product is consisting essentially of no gluten.

15. The pasta product of claim 14, wherein the pasta product comprises about 8-28 dwt % pulse fiber.

16. The pasta product of claim 14, wherein the pasta product comprises about 30-90 dwt. % pulse starch.

17. The pasta product of claim 14, wherein the pasta product comprises about 68-92 dwt. % pulse carbohydrate.

18. The pasta product of claim 14, further comprising an addition of up to about 50 dwt. % pulse protein peptides, soluble pulse protein, pulse albumin or combinations thereof.

19. The pasta product of claim 14, further comprising:
a) about 70-92 dwt. % pulse carbohydrate;
b) about 6-24 dwt. % pulse protein; and
c) less than about 6 dwt. % pulse fat.

20. The pasta product of claim 19, wherein the pulse carbohydrate is at least partially precooked.
